(19) United States
(12) Patent Application Publication
(10) Pub. No.: US 2025/0356256 A1
(43) Pub. Date: Nov. 20, 2025

(54) Error-Resistant Insight Summarization Using Generative AI

(71) Applicant: Google LLC, Mountain View, CA (US)

(72) Inventors: Matthew Thompson Walter, Ladera Ranch, CA (US); Eehpyoung Rhee, Seattle, WA (US); Soham Anand Hinduja, San Francisco, CA (US); Eddie Lee Tribaldos, Oakland, CA (US); Omer Shakil, Sunnyvale, CA (US)

(21) Appl. No.: 18/926,763

(22) Filed: Oct. 25, 2024

Related U.S. Application Data
(60) Provisional application No. 63/649,713, filed on May 20, 2024.

(51) Int. Cl. G06N 20/00; G06F 18/24

(52) U.S. Cl. CPC G06N 20/00; G06F 18/24765

(57) ABSTRACT

Systems and methods for machine-learned generation of data insight summaries are provided. A computing system can obtain numerical time series data comprising a plurality of numerical values associated with a plurality of times. The computing system can identify, based on the numerical time series data, one or more first mathematical relationships in the numerical time series data. The computing system can generate, based at least in part on the mathematical relationships, a first input context comprising first natural language data indicative of the mathematical relationships. The computing system can provide the first input context to a first machine-learned sequence processing model. The first machine-learned sequence processing model can generate, based at least in part on the first input context, one or more outputs describing the one or more first mathematical relationships. The computing system can output the one or more outputs.

### CROSS-REFERENCE TO RELATED APPLICATIONS

The present application is based upon and claims the right of priority to U.S. Provisional Patent Application No. 63/649,713, filed on May 20, 2024, the disclosure of which is hereby incorporated by reference herein in its entirety for all purposes.

### FIELD

The present disclosure relates generally to machine learning. More particularly, the present disclosure relates to systems and methods for using machine learning to summarize insights extracted from time series data, in a manner that minimizes errors associated with machine-learned sequence generation.

### BACKGROUND

A computer can receive input(s). The computer can execute instructions to process the input(s) to generate output(s) using a parameterized model. The computer can obtain feedback on its performance in generating the outputs with the model. The computer can generate feedback by evaluating its performance. The computer can receive feedback from an external source. The computer can update parameters of the model based on the feedback to improve its performance. In this manner, the computer can iteratively “learn” to generate the desired outputs. The resulting model is often referred to as a machine-learned model.

Some online content is supported by revenue-generating third-party content, which can include audio, video, text, images, web searches, and more. Publishers of the online content can allow the providers of the third-party content to provide the third-party content on web property (e.g., web pages) owned by the publisher of the online content. When the third-party content is displayed or otherwise provided to users of the web property owned by the publisher, an “impression” is generated, indicating that the third-party content has been shown. Third-party content providers can utilize numbers of impressions on different web properties to drive their publishing strategy and campaigns. The number of impressions and other metrics can be tracked in data analytics tools by the third-party content providers.

### SUMMARY

Aspects and advantages of embodiments of the present disclosure will be set forth in part in the following description, or can be learned from the description, or can be learned through practice of the embodiments.

One example aspect of the present disclosure is directed to an example method. The example method can include obtaining, by a computing system comprising one or more computing devices, numerical time series data comprising a plurality of numerical values associated with a plurality of times. The example method can include identifying, by the computing system based on the numerical time series data, one or more first mathematical relationships in the numerical time series data. The example method can include generating, by the computing system based at least in part on the one or more first mathematical relationships, a first input context comprising first natural language data indicative of the one or more first mathematical relationships. The example method can include providing, by the computing system, the first input context to a first machine-learned sequence processing model. The example method can include generating, by the first machine-learned sequence processing model based at least in part on the first input context, one or more outputs describing the one or more first mathematical relationships. The example method can include outputting, by the computing system, the one or more outputs.

In the example method, the one or more outputs can include a first candidate output. The example method can include providing, by the computing system to a second machine-learned sequence processing model, a second input context comprising at least one of the first natural language data and second data indicative of the one or more first mathematical relationships. The example method can include providing, by the computing system to the second machine-learned sequence processing model, the first candidate output. The example method can include generating, by the second machine-learned sequence processing model based on the first candidate output and the second input context, an accuracy score indicative of a degree to which the first candidate output accurately describes the one or more first mathematical relationships. In the example method, outputting the one or more outputs can be based at least in part on the accuracy score.

The example method can include determining, by the computing system based at least in part on the accuracy score, whether to generate a second candidate output using the first machine-learned sequence processing model.

The example method can include generating, by the computing system using the second machine-learned sequence processing model based at least in part on the first candidate output, an evaluation score comprising at least one of: a readability score; and an actionability score. In the example method, outputting the one or more outputs can be based at least in part on the evaluation score.

The example method can include classifying, by the computing system, the one or more first mathematical relationships into one or more classes of a plurality of mathematical relationship classes. In the example method, a format of the first natural language data of the first input context can include a class-dependent structured format associated with the one or more classes.

In the example method, the plurality of mathematical relationship classes can include a single-line time series trend class; a multiple-line time series trend class; a first comparison class comprising one or more comparisons between single numerical values; a second comparison class comprising comparisons between non-time-series pluralities of numerical values; a multiple-numerical-value non-comparison class; and a single-numerical-value non-comparison class.

The example method can include receiving, by the computing system from a user, user input indicative of a user evaluation of the one or more outputs. The example method can include updating, by the computing system based on the user input, at least one of the first machine-learned sequence processing model and a second machine-learned sequence processing model configured to evaluate outputs of the first machine-learned sequence processing model.

In the example method, the numerical time series data can include user-specific time series data associated with a user. The example method can include obtaining, by the computing system, general time series data associated with a plurality of users. In the example method, the one or more first mathematical relationships can include a comparison between the general time series data and the user-specific time series data.

In the example method, the first input context can include one or more fill-in-the-blank output templates. In the example method, the first input context can include one or more instructions to fill in one or more parts of at least one of the one or more fill-in-the-blank output templates.

In the example method, each of the one or more fill-in-the-blank output templates can include: at least one title portion; at least one summary portion; and at least one segment analysis portion.

The example method can include providing, by the computing system to the first machine-learned sequence processing model, a plurality of input-output pairs. In the example method, each input-output pair of the plurality of input-output pairs can include at least one input value comprising second natural language data indicative of one or more second mathematical relationships. In the example method, each input-output pair of the plurality of input-output pairs can include at least one output value comprising a natural language description of the one or more second mathematical relationships. In the example method, the one or more outputs can be generated based at least in part on the plurality of input-output pairs.

In the example method, the first input context can include general content analytics knowledge. In the example method, the one or more outputs can be generated based at least in part on the general content analytics knowledge.

The example method can include identifying, by the computing system based at least in part on the numerical time series data, one or more second mathematical relationships in one or more subsets of the numerical time series data. The example method can include generating, by the computing system based at least in part on the one or more second mathematical relationships, second natural language data indicative of the one or more second mathematical relationships. The example method can include generating, by the computing system based at least in part on the one or more second mathematical relationships, second natural language data indicative of the one or more second mathematical relationships. The example method can include providing, by the computing system to the first machine-learned sequence processing model, the second natural language data as part of the first input context or a second input context. In the example method, the one or more outputs can be generated based at least in part on the second natural language data. In the example method, the one or more outputs can include a segment analysis.

The example method can include generating, by the computing system based at least in part on the one or more first mathematical relationships, a chart associated with the one or more outputs. The example method can include providing, by the computing system, the chart to a user. The example method can include providing, by the computing system to the user, an interface component configured to cause the chart to be filtered according to the one or more subsets when the interface component is interacted with by the user.

In the example method, each numerical value can be associated with one or more times and one or more other properties different from time. In the example method, identifying the one or more second mathematical relationships can include determining, based on the one or more other properties different from time, the one or more subsets.

In the example method, the one or more other properties different from time can include at least one of: demographic data associated with one or more users; and internet traffic data associated with one or more internet interactions.

In the example method, the one or more subsets can be determined based at least in part on a comparison between the one or more subsets and the numerical time series data as a whole.

In the example method, the numerical time series data can include content analytics data.

Another example aspect of the present disclosure is directed to an example computing system. The example computing system can include one or more processors. The example computing system can include one or more non-transitory computer-readable media storing instructions that are executable by the one or more processors to cause the computing system to perform example operations. The example operations can include obtaining numerical time series data comprising a plurality of numerical values associated with a plurality of times. The example operations can include identifying, by the computing system based on the numerical time series data, one or more first mathematical relationships in the numerical time series data. The example operations can include generating, based at least in part on the one or more first mathematical relationships, a first input context comprising first natural language data indicative of the one or more first mathematical relationships. The example operations can include providing the first input context to a first machine-learned sequence processing model. The example operations can include generating, by the first machine-learned sequence processing model based at least in part on the first input context, one or more outputs describing the one or more first mathematical relationships. The example operations can include outputting the one or more outputs.

Another example aspect of the present disclosure is directed to one or more non-transitory computer-readable media. The one or more non-transitory computer-readable media can store instructions that are executable by a computing system to perform example operations. The example operations can include obtaining numerical time series data comprising a plurality of numerical values associated with a plurality of times. The example operations can include identifying, by the computing system based on the numerical time series data, one or more first mathematical relationships in the numerical time series data. The example operations can include generating, based at least in part on the one or more first mathematical relationships, a first input context comprising first natural language data indicative of the one or more first mathematical relationships. The example operations can include providing the first input context to a first machine-learned sequence processing model. The example operations can include generating, by the first machine-learned sequence processing model based at least in part on the first input context, one or more outputs describing the one or more first mathematical relationships. The example operations can include outputting the one or more outputs.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1 depicts a block diagram of an example system for generating insight summaries according to example embodiments of the present disclosure.

FIG. 2 depicts a block diagram of an example system for generating insight summaries according to example embodiments of the present disclosure.

FIG. 3 depicts a block diagram of an example system for generating insight summaries according to example embodiments of the present disclosure.

FIG. 4 depicts a block diagram of an example system for generating insight summaries according to example embodiments of the present disclosure.

FIG. 5 depicts a block diagram of an example system for training machine-learned models according to example embodiments of the present disclosure.

FIG. 6 depicts a block diagram of an example system for generating insight summaries according to example embodiments of the present disclosure.

FIG. 7 depicts a block diagram of an example content management system according to example embodiments of the present disclosure.

FIG. 8 depicts a flow chart diagram of an example method to generate insight summaries according to example embodiments of the present disclosure.

FIG. 9A depicts a block diagram of an example computing system that performs insight summary generation according to example embodiments of the present disclosure.

FIG. 9B depicts a block diagram of an example computing device that performs insight summary generation according to example embodiments of the present disclosure.

FIG. 9C depicts a block diagram of an example computing device that performs insight summary generation according to example embodiments of the present disclosure.

FIG. 10 is a flow chart diagram illustrating an example method for training a machine-learned model according to example implementations of aspects of the present disclosure;

FIG. 11 is a block diagram of an example processing flow for using machine-learned model(s) to process input(s) to generate output(s) according to example implementations of aspects of the present disclosure;

FIG. 12 is a block diagram of an example sequence processing model according to example implementations of aspects of the present disclosure;

FIG. 13 is a block diagram of an example technique for populating an example input sequence for processing by a sequence processing model according to example implementations of aspects of the present disclosure;

FIG. 14 is a block diagram of an example model development platform according to example implementations of aspects of the present disclosure;

FIG. 15 is a block diagram of an example training workflow for training a machine-learned model according to example implementations of aspects of the present disclosure; and

FIG. 16 is a block diagram of an inference system for operating one or more machine-learned model(s) to perform inference according to example implementations of aspects of the present disclosure.

Reference numerals that are repeated across plural figures are intended to identify the same features in various implementations.

### DETAILED DESCRIPTION

### Overview

Generally, the present disclosure is directed to machine-learned generation of insight summaries based on numerical time series data (e.g., content analytics time series data, etc.). A computing system can perform a structured analysis (e.g., mathematical or algorithmic analysis, etc.) on the time series data to generate insights (e.g., mathematical insights, etc.) about the time series data. For example, the structured analysis can identify particular trends in the data over time, such as a recent increase or decrease in a numerical value (e.g., impressions, click-through rate, conversion rate, engagement rate, etc.) associated with the time series data. The structured analysis system can provide insight data in a structured format, such as a structured natural language prompt describing one or more mathematical insights, to a generative machine-learned model (e.g., generative language model), and the model can generate a summary of the insight data in a natural language (e.g., English, etc.). The insight summary can then be provided to a user to help the user better understand aspects of the data.

In some instances, example systems can use various methods to reduce a risk of error associated with language generation. For example, some machine-learned language generation models may not include a mathematical analysis component or a fact-checking component, and thus may in some instances generate mathematically or factually erroneous outputs if no error prevention methods are employed. Example embodiments of the present disclosure can include various techniques for error prevention, detection, and correction.

For example, in some instances, input data can be converted from a format that a machine-learned model cannot consistently process accurately to a format associated with better processing accuracy. For example, in some instances, numerical time series data can include a plurality of raw numerical values associated with a plurality of times, and a machine-learned model (e.g., language generation model) can include a model that is not necessarily well equipped to accurately process the raw time series data. In such instances, a structured analysis can include a deterministic analysis (e.g., mathematical analysis, algorithmic analysis, etc.) that is guaranteed to process the numerical time series data in a mathematically accurate way, and can generate mathematical insight data in an input format that may enable the machine-learned model to generate more factually accurate outputs. For example, in some instances, the structured analysis can identify one or more mathematical properties or other properties of the numerical time series data (e.g., time granularity, time range, metric being measured, highest value or lowest value during a time period of interest, percentage increase or decrease, absolute increase or decrease, etc.), and can generate a structured input context comprising a natural language description of the properties (e.g., “Highest value: 23,061.08 on November 4”; “Year-over-year change (by percentage): 12 percent increase”; etc.). In this manner, for instance, numerical time series data that cannot be accurately processed by some machine-learned models (e.g., generative language models) can be converted to an input format (e.g., structured natural language input format) that may better enable the model to generate factually accurate outputs.

In some instances, a computing system can identify a class of mathematical relationships to which a mathematical insight belongs and can format an input to the machine-learned model in a class-dependent structured format. For example, a first class of mathematical relationships (e.g., comparison between two single numerical values, such as “How many users this week compared to last week?”) may be associated with a first class-dependent structured format that provides mathematical insight data in a format that tends to enable accurate machine-learned outputs describing mathematical insights in the first class, but may not enable accurate machine-learned outputs describing mathematical insights in a second class of mathematical relationships (e.g., segmented comparison between two sets of multi-segment numerical data, such as “Number of users this week compared to last week broken down by device”). In such instances, a computing system can generate, responsive to identifying a mathematical relationship in the second class, an input context in a second class-dependent structured format associated with the second class of mathematical relationships. In this manner, for instance, a machine-learned model can be provided with input context in a format that maximizes the probability of generating a factually accurate output.

In some instances, a boundary between classes of mathematical relationships can be defined at least in part by a machine-learned model's ability to process different members of a class using a common structure. As a non-limiting illustrative example, a machine-learned model may be better able to accurately generate outputs describing mathematical relationships with temporal components if it receives an input comprising natural language content (e.g., “earlier,” “later,” “before,” “after,” etc.) describing the temporal components in natural language. Continuing the non-limiting illustrative example, the machine-learned model may generate higher-quality outputs describing non-temporal relationships if its inputs lack temporal natural language content. In such an example, a plurality of mathematical relationships can be divided into classes based at least in part on the existence or nonexistence of a temporal component to the relationships. Other divisions are possible (e.g., presence or absence of spatial component such as “near” or “far,” number of segments or segment dimensions of a metric being measured, etc.). In some instances, an example set of relationship classes can include one or more of a single-numerical-value class (e.g., number of users in the past week), a class comprising comparisons between single values (e.g., “How many users this week compared to last week?”), a multiple-numerical-value class (e.g., number of users in the past week, broken down by device), a multiple-value-with-comparison class (e.g., number of users this week compared to last week, broken down by browser), a single-property time series class (e.g., trends in user count over the past month), and a multiple-property time series class (e.g., trends in user count over the past month, broken down by device, etc.).

As another example, in some instances, the generative machine-learned model can generate multiple candidate summaries associated with multiple potential insights, and the candidate summaries can be evaluated by one or more separate machine-learned evaluation models. For example, a separate evaluation model can be separately trained to detect whether mathematical or factual claims in a natural language output are supported by the input data that the generated sequence is based on. The evaluation model(s) can also evaluate candidate outputs to detect whether the outputs comply with other goals, such as compliance with formatting instructions, readability, actionability, and the like. In some instances, a computing system can select, based on the evaluations, one best output from the candidate outputs to display to a user. In some instances, an evaluation threshold (e.g., accuracy confidence threshold, readability score threshold, etc.) can be used, and the computing system can decide not to show any insight summaries to a user if none of the candidate outputs meet the threshold. In this manner, for instance, a computing system can ensure that any machine-learned output provided to a user will be accurate and useful.

In some instances, a computing system can dynamically determine a number of candidate summaries to generate. For example, in some instances, a generative machine-learned model can generate a first insight summary, and the first insight summary can be evaluated by an evaluation model. In some instances, if the first insight summary is satisfactory (e.g., receives an evaluation score above a predefined threshold, etc.), the computing system can output the first insight summary without generating additional summaries. In some instances, if the first insight summary is unsatisfactory, the generative machine-learned model can generate a second insight summary, and the evaluation model can evaluate the second insight summary. In this manner, for instance, systems and methods according to some aspects of the present disclosure can provide improved output accuracy compared to some alternative implementations (e.g., implementations without an evaluation model), while providing reduced computational cost compared to some alternative implementations (e.g., implementations comprising unconditional generation of the second insight summary, etc.).

As another example, the output generation process can include various additional guardrails to reduce a risk of generating flawed (e.g., mathematically flawed, improperly formatted, too long or short, etc.) candidate outputs. For example, an input to the generative machine-learned model can include a fill-in-the-blank-style template, along with an instruction to fill in the blanks based on the structured input data. In this manner, for instance, the range of possible machine-learned outputs can be narrowed to a range that is likely to generate high-quality outputs (e.g., likely to comply with formatting goals and readability goals, unlikely to result in mathematically erroneous outputs, etc.). As another example, an input to the generative machine-learned model can include multiple input-output pairs that include a structured insight data input and a high-quality insight summarization output. In this manner, for instance, example embodiments can capitalize on the in-context learning capabilities of some generative machine-learned models to improve the quality of generated candidate outputs. As another example, an input to the generative machine-learned model can include general knowledge (e.g., retrieved factual knowledge, general content analytics knowledge, etc.) that may reduce an error rate or otherwise improve the candidate outputs by providing relevant context to capitalize on the in-context learning capabilities of some generative machine-learned models.

As another example, the insight summarization and evaluation processes can be iteratively improved based on feedback from users. For example, a system can provide a generated insight summarization to a user, along with an input component (e.g., thumbs up/down button, etc.) for the user to provide feedback about the quality (e.g., accuracy, relevance, interestingness, usefulness, actionability, etc.) of the generated insight summarization. Based on feedback received via the input component, a computing system can further train the evaluation model, the generative machine-learned model, or both to further improve the quality of generated outputs. Additionally or alternatively, one or more aspects of a set of class-dependent structured input formats (e.g., number and definition of classes; sets of input-output pairs, fill-in-the-blank templates, instruction content, etc.) can be optimized based on the feedback.

In some instances, an example generated output can include a title; a brief summary of the structured insight data (e.g., trend, etc.); and a segment analysis describing which data segments (e.g., market segments, demographic segments, etc.) may be driving an identified trend or other insight. In some instances, the generated output can be provided to the user along with a chart depicting the data on which the insight is based (e.g., trendline chart, etc.). To cause the generative model to generate an output including a title, brief summary, and segment analysis, an input to the generative model can include a fill-in-the-blank template having a title portion, a summary portion, and a segment analysis portion; input-output pairs having a title, summary, and segment analysis in the outputs; an instruction to generate a title, brief summary, and segment analysis; or other relevant input. To generate the chart, a computing system can use standard mathematical tools to generate charts directly from time series data, structured insight data, or other data (e.g., without the use of a machine-learned model). To aid the generative model in generating the segment analysis, the structured insight data can include structured segment analysis data.

In some instances, an insight can include or be based on a comparison between user-specific data (e.g., data associated with a particular account on a content analytics platform, etc.) and general data associated with multiple users (e.g., all users; users in a particular industry or market segment; content providers of a similar size compared to a user of interest; etc.). As an illustrative example, if all clothing websites see an increase in traffic each weekend, then a structured analysis system may determine that a weekend-based increase in traffic is not a very interesting insight to a clothing content provider. However, if the clothing content provider saw a much larger or smaller spike in traffic compared to similar content providers or compared to other weekends, that comparative insight may be more interesting to some users (e.g., as measured by user feedback, etc.).

In some instances, a segment analysis insight can include or be based on a comparison between a particular segment and the time series data as a whole. As an illustrative example, if a particular content provider (e.g., provider of content associated with a local brick and mortar business) receives nearly all of its traffic from viewers in a particular location (e.g., state, country, etc.), then an insight that a recent increase in traffic comes from viewers in that location may not be interesting. However, if the same content provider sees traffic from people of all ages, and 80 percent of a recent increase is attributable to an increase in traffic from viewers over 65 years old, that may be a more interesting, relevant, or usable insight.

In some instances, the time series data analyzed, along with the insights generated from the time series data, can include content analytics data and content analytics insights. Content analytics data can include, for example, any data indicative of one or more interactions associated with a content item (e.g., impressions, clicks, user actions, interactions with related content connected to the content, etc.). For example, interaction data can include data associated with a content item, viewer, item of interest described by or otherwise associated with the content item, content interaction, related or connected content, website, or other interaction data. In some instances, content analytics data can include segment data (e.g., item segments of items described by a content item, viewership segments, content publishing campaign segments, related or connected content segments, website segments, etc.), which can include segment data based on default segmentations and segment data based on user-defined custom segments. As a non-limiting illustrative example, a content analytics insight could include, for example, trend data indicating that clickthrough rates have increased in the past week, and segment analysis data indicating that traffic from a particular website is a key driver of the increase.

In some implementations, the techniques disclosed herein enable artificial intelligence to generate insight summaries. Artificial intelligence (AI) is a segment of computer science that focuses on the creation of models that can perform tasks with little to no human intervention. Artificial intelligence systems can utilize, for example, machine learning, natural language processing, and computer vision. Machine learning, and its subsets, such as deep learning, focus on developing models that can infer outputs from data. The outputs can include, for example, predictions and/or classifications. Natural language processing focuses on analyzing and generating human language. Computer vision focuses on analyzing and interpreting images and videos. Artificial intelligence systems can include generative models that generate new content, such as images, videos, text, audio, and/or other content, in response to input prompts and/or based on other information.

Systems and methods of the present disclosure can provide a variety of technical effects and benefits, such as improved accuracy of machine-learned outputs; reduced computational cost (e.g., electricity cost, processor usage, etc.) of machine-learned language generation; and reduced cost (e.g., computational cost, labor cost, etc.) of insight extraction.

For example, in some instances, systems and methods according to example aspects of the present disclosure can provide improved accuracy of machine-learned outputs. For example, some alternative methods may employ machine-learned language generation models that do not include a mathematical analysis component or a fact-checking component, which may in some instances generate mathematically or factually erroneous outputs. For example, some alternative methods may provide raw or unstructured data (e.g., time series data, etc.) to a machine-learned language generation model, which may cause the language generation model to generate language outputs that include mathematically or factually incorrect assertions. Advantageously, systems and methods according to aspects of the present disclosure can provided structured input contexts having a structure that increases a likelihood that any given candidate output is mathematically and factually accurate. For example, in some instances, a structured input context can include a natural language description of a mathematical insight known to be accurate, and the natural language description can be provided to a model that has been extensively trained on natural language training data, thereby increasing an alignment between the input data and the model's training. As another example, in some instances, a structured input context can include a fill-in-the-blank template component. Such a template component can advantageously reduce a number of degrees of freedom of the machine-learned model, thereby reducing a risk of error by reducing a number of possible failure points. As another example, in some instances, a structured input context can have a class-dependent structured format associated with a specific class of mathematical relationships, which can provide various additional benefits. For example, in some instances, using a plurality of class-dependent structured formats can more closely align a structured input context with a relationship class, thereby increasing a machine-learned generation accuracy. As another example, in some instances, using a plurality of class-dependent structured input formats can enable narrower or more specific structured formats (e.g., more specific class-dependent fill-in-the-blank templates, etc.), thereby further reducing a number of degrees of freedom of the machine-learned output and further reducing a number of possible points of failure.

As another example, some alternative methods may be configured to provide machine-generated outputs (e.g., including mathematically or factually erroneous outputs) to a user without a mechanism to evaluate the outputs' accuracy or to filter out inaccurate outputs. Advantageously, systems and methods according to some aspects of the present disclosure can use a separate machine-learned model to estimate an accuracy level of the first machine-learned model's output, and can filter out inaccurate outputs. For example, in some instances, systems and methods according to example aspects of the present disclosure can generate a plurality of candidate outputs, and can only output the best (e.g., most accurate, etc.) outputs of the plurality of candidate outputs, thereby improving output quality (e.g., factual accuracy, etc.) compared to some alternative implementations. In some instances, the second machine-learned model can include a model architecture (e.g., sentence embedding architecture, etc.) that may be better equipped to determine whether a generated output is factually supported by structured insight data compared to some alternative architectures (e.g., autoregressive generation architecture, etc.). Additionally, in some instances, a second machine-learned model can be provided with one or more inputs (e.g., input comprising both a machine-learned natural language output and the structured insight data used to generate the output) that may enable a more accurate determination of whether a generated output is factually supported by structured insight data compared to some alternative inputs (e.g., input comprising structured insight data, without a candidate output to compare it to). In this manner, for instance, systems and methods according to the present disclosure can reduce a rate of mathematical and factual errors in outputs generated by a machine-learned generative language model itself, and in outputs provided to the user by a computing system comprising the machine-learned generative language model, compared to alternative methods with fewer or less effective error prevention mechanisms.

As another example, systems and methods according to example aspects of the present disclosure may in some instances reduce a computational cost of generating machine-learned insight summarization outputs compared to some alternative methods with a similar accuracy. For example, in some instances, a mathematical and factual accuracy of a machine-learned language output can be increased by increasing a complexity or size (e.g., number of parameters, etc.) of the machine-learned model generating the output. However, increasing a complexity of a machine-learned model can also increase a computational cost (e.g., electricity cost, processor usage, memory usage, hardware cost, etc.) of training the machine-learned model and a computational cost of generating outputs with the machine-learned model after training. In some instances, the increased cost can be very large compared to the improvement in accuracy. For example, a large increase in model complexity (e.g., doubling of parameter count, ten-fold increase in parameter count, etc.) may only lead to a small marginal increase in accuracy (e.g., five percent increase, 25 percent increase, etc.) in a simple (e.g., elementary-school-level) mathematical reasoning task, which may be much simpler mathematically than structured data analysis performed according to some aspects of the present disclosure. Additionally, the increase in accuracy may in some instances have a log-linear relationship with model complexity, meaning that increased complexity will lead to diminishing returns in accuracy as model complexity increases. Advantageously, systems and methods according to some aspects of the present disclosure can provide substantially improved mathematical accuracy (e.g., at or near 100 percent, etc.) compared to alternative methods, without increasing a complexity of the machine-learned language model. In this manner, for instance, systems and methods according to some aspects of the present disclosure can provide machine-learned insight summarization at reduced computational cost (e.g., model training costs, inference costs, etc.) compared to alternative methods having a similar mathematical accuracy. As another example, in some instances, systems and methods according to some aspects of the present disclosure can reduce a computational cost of machine-learned insight summarization by dynamically determining a number of machine-learned inference actions to perform. For example, in some instances, an evaluation model can evaluate a first candidate output and, if an output quality of the first candidate output is above a threshold, the computing system can accept the candidate output and output it to a user. In this manner, for instances, a number of machine-learned inference actions can be reduced compared to some alternative implementations (e.g., implementations having a fixed number of candidate outputs), thereby reducing a computational cost (e.g., electricity cost, memory footprint, processor usage, etc.) compared to some alternative implementations.

A technical effect of example implementations of the present disclosure is increased energy efficiency in performing operations using machine-learned models, thereby improving the functioning of computers implementing such models. For instance, example implementations can provide for more energy-efficient training operations or model updates by providing error correction using lightweight (e.g., having a lower computational cost or model complexity compared to a machine-learned generative language model) evaluation models or structured data analysis techniques. In some scenarios, increased energy efficiency can provide for less energy to be used to perform a given number of inference or training tasks (e.g., less energy expended to maintain the model in memory, less energy expended to perform calculations within the model, such as computing gradients, backpropagating a loss, etc.). In some scenarios, increased energy efficiency can provide for more inference or training tasks to be completed for a given energy budget (e.g., a larger quantity of training iterations, etc.). In some scenarios, greater expressivity afforded by systems and methods of the present disclosure can provide for a given level of functionality to be obtained in fewer training iterations, thereby expending a smaller energy budget. In some scenarios, greater expressivity afforded by systems and methods of the present disclosure can provide for an extended level of functionality to be obtained in a given number of training iterations, thereby more efficiently using a given energy budget.

In this manner, for instance, the improved energy efficiency of example implementations of the present disclosure can reduce an amount of pollution or other waste associated with implementing machine-learned models and systems, thereby advancing the field of machine-learning and artificial intelligence as a whole. The amount of pollution can be reduced in toto (e.g., an absolute magnitude thereof) or on a normalized basis (e.g., energy per task, per model size, etc.). For example, an amount of CO2 released (e.g., by a power source) in association with training and execution of machine-learned models can be reduced by implementing more energy-efficient training or inference operations. An amount of heat pollution in an environment (e.g., by the processors/storage locations) can be reduced by implementing more energy-efficient training or inference operations.

With reference now to the Figures, example embodiments of the present disclosure will be discussed in further detail.

### Example Systems

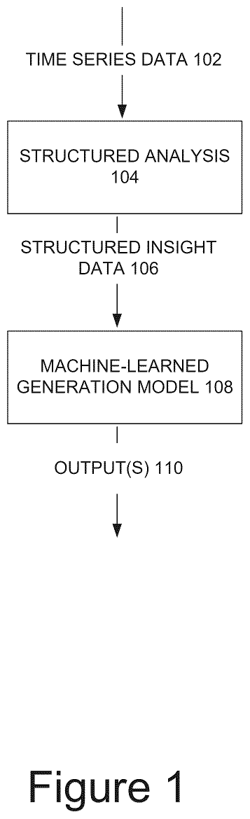

FIG. 1 depicts a block diagram of an example system for machine-learned insight summarization according to example aspects of the present disclosure. A structured analysis system 104 can process time series data 102 to generate structured insight data 106. The structured insight data 106 can be provided to a machine-learned generation model 108, which can generate one or more output(s) 110 based on the structured insight data 106.

Time series data 102 can include, for example, data comprising a plurality of data items associated with a plurality of times. Each data item of the time series data 102 can include one type or many types of data, and each data item may have a data type that is the same as or different from a data type of another data item of the time series data 102. Example data types for the time series data 102 can include any type of computer-readable data, such as numerical data, binary data, text data, structured data (e.g., XML, JSON, HTML, object, struct, etc.), or other computer-readable data type.

In some instances, time series data 102 can include content analytics data. Content analytics data can include, for example, any data indicative of one or more interactions associated with a content item (e.g., impressions, clicks, user actions, interactions with related content connected to the content item, etc.). For example, interaction data can include data associated with a content item (e.g., format data, content data, identification number, filename, host server, etc.), viewer (e.g., location; demographic information; viewer interests such as hobbies, etc.; device data such as browser(s), application(s), operating system, device name such as Pixel 8 Pro, etc.; associated keywords such as search keywords entered; new or returning viewer status; etc.), item of interest described by or otherwise associated with a content item (e.g., category, name, identification number, version such as size or color, etc.), content interaction (e.g., date of a view, click, visit, purchase, etc.; source of interaction such as search, email, social media, links, etc.; keyword associated with interaction; funnel data describing series of interactions such as first view→first visit→first user action of interest, etc.; interaction completion or abandonment data; etc.), related or connected content (e.g., publication data such as date, title, etc.; game data such as character data, in-game achievement data, etc.), website or other technical component (e.g., filename data, uniform resource locator (URL) data, hypertext markup language (HTML) data such as class name of an HTML element associated with an interaction, etc.). In some instances, content analytics data can include segment data (e.g., product segments, viewership segments, content publishing campaign segments, related or connected content segments, website segments, etc.), which can include segment data based on default segmentations and segment data based on user-defined custom segments. In some instances, content analytics data can include quantitative data based on or otherwise associated with one or more (e.g., a plurality of) content interactions. For example, in some instances, content analytics data can include metrics associated with a plurality of interactions, such as count data (e.g., number of impressions in a time period, number of users, number of sessions, etc.), rate or percentage data (e.g., bounce rate, clickthrough rate, average session duration, average pages per session, ratio of new to returning visitors, average time on page, conversion rates, etc.), cost data (e.g., cost per click, cost per conversion, etc.) or other aggregate data associated with a plurality of content interactions. In some instances, a content interaction can include an internet-based content interaction, and data associated with the internet-based content interaction can include internet traffic data associated with one or more internet interactions.

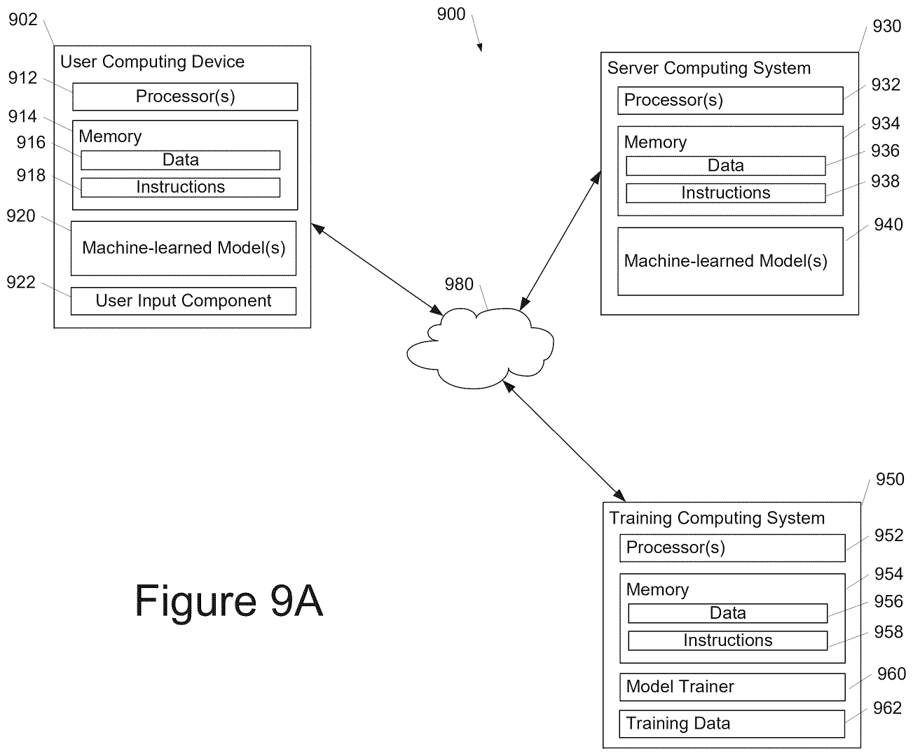

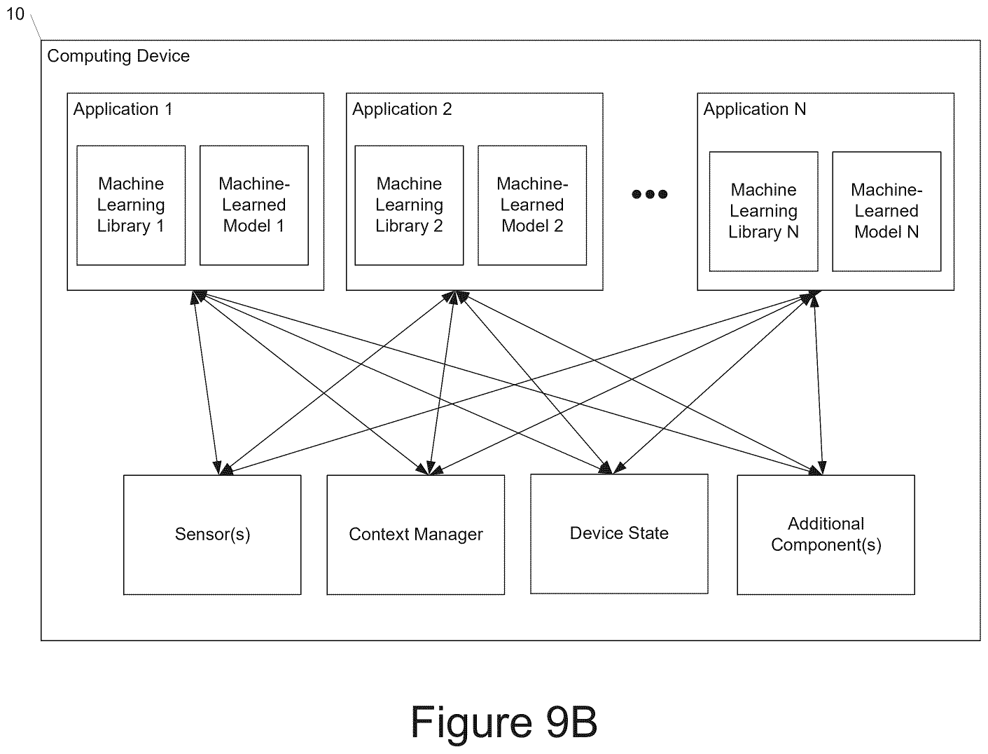

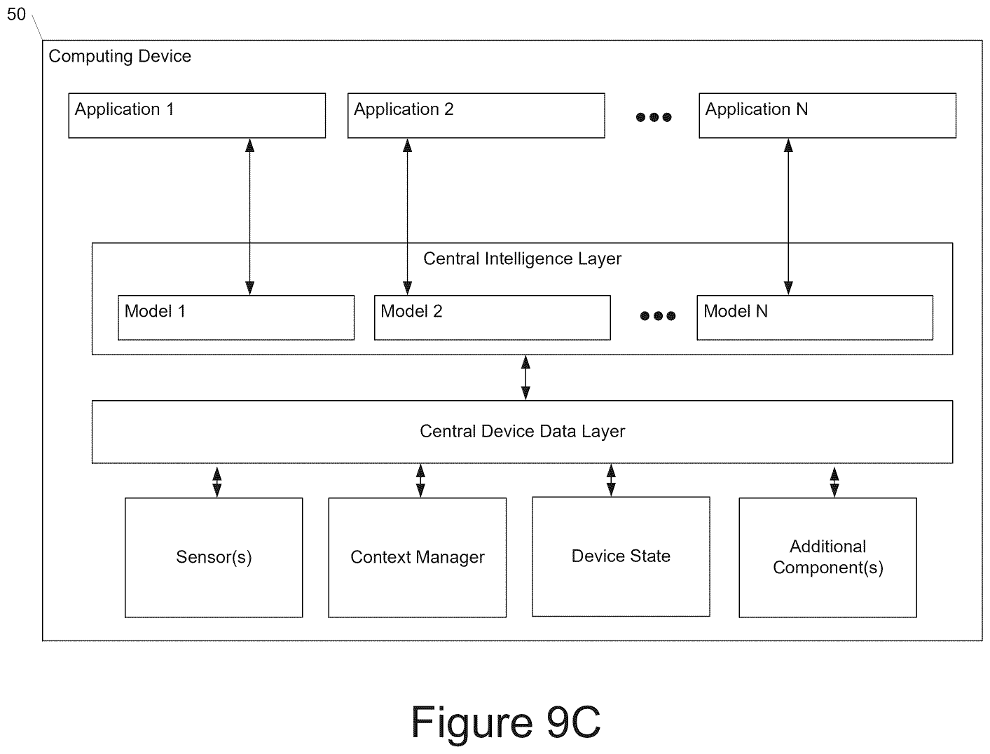

A structured analysis system 104 can be or include one or more, firmware, or hardware components configured to process time series data 102 to generate structured insight data 106. In some instances, the structured analysis system 104 can be, comprise, be comprised by, or share one or more properties with a computing device or system described below with respect to FIGS. 9A-9C (e.g., server computing system 930, training computing system 950, computing device 10, computing device 50, etc.).

Structured analysis can include, for example, any operation for generating structured insight data 106 based on time series data 102. In some instances, structured analysis can include mathematical analysis (e.g., statistical analysis, etc.), algorithmic analysis, and the like. In some instances, structured analysis can include deterministic (e.g., non-random, etc.) operations. A deterministic operation can be an operation that generates, when given the same input multiple times, the same outputs every time the same input is received. In some instances, a structured analysis can include various kinds of statistical aggregation (e.g., counts; totals; sums; means; medians; ratios or rates such as clickthrough rate, cost per click, impressions per day or other time period, etc.). In some instances, a structured analysis can include deterministic mathematical operations performed by a computing system (e.g., mathematical operations of a programming language configured to reliably perform mathematical functions, such as arithmetic, statistical aggregation, calculus, or other mathematical functions).

In some instances, a structured analysis can include one or more comparisons between one or more first subsets of the time series data 102 and one or more second subsets of the time series data 102. For example, a structured analysis can include a trend detection operation comprising one or more comparisons between one or more first subsets associated with a first plurality of times and one or more second subsets associated with a second plurality of times. As a non-limiting illustrative example, a structured analysis can compare, for each of a plurality of content analytics variables, a first plurality of values of the content analytics variable over a first plurality of times (e.g., recent time period such as the past 24 hours, past 48 hours, past week, etc.) to a second plurality of values of the content analytics variable over a second plurality of times (e.g., less recent time period such as prior day, week, month, or year before the recent time period began; lifetime of a user account or other content analytics account, e.g., at all times before the recent time period began; etc.). In some instances, a structured analysis can include a comparison between a first trend associated with a first time period (e.g., most recent 24 hours, etc.) and a second trend associated with a second time period (e.g., same date or holiday one year earlier; same day of the week or month, one week or month earlier, etc.) or plurality of second time periods (e.g., average trend on same day every week, month, year, etc.).

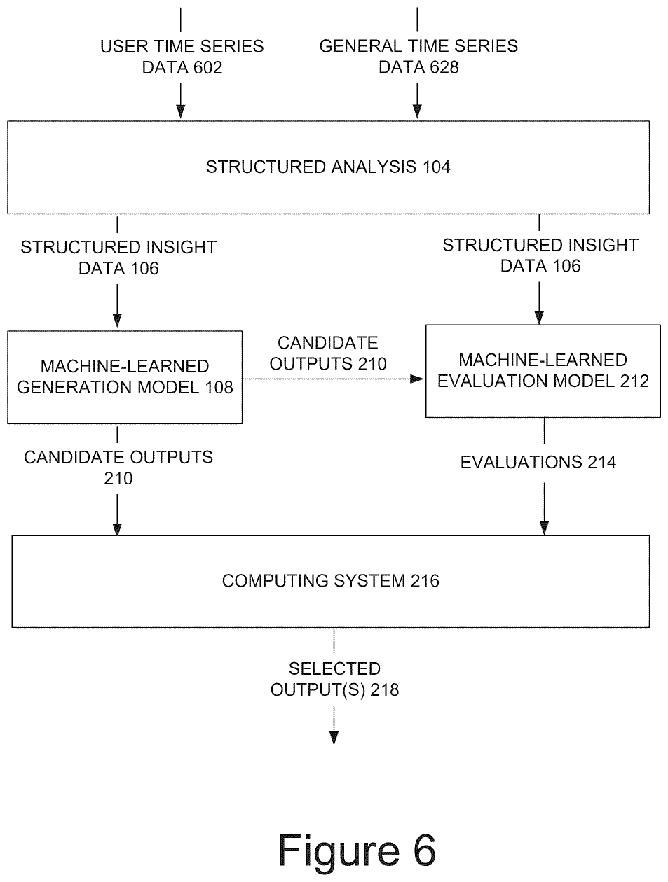

In some instances, a comparison between a first subset and second subset of the time series data 102 can include a benchmarking operation, wherein first time series data 102 associated with a user or account of interest (e.g., user to whom the selected output(s) 218 will be provided, etc.) can be compared to second time series data 102 associated with a plurality of users or accounts. Further details of an example benchmarking comparison are provided below with respect to FIG. 6.

In some instances, a comparison between a first subset and second subset of the time series data 102 can include a segment analysis, wherein the segment analysis subsets are defined by one or more properties different from time or user/account identity. For example, in some instances, a segment analysis can include a comparison between a first trend associated with one or more time series data 102 variables, and a second trend associated with the same one or more time series data 102 variables. As a non-limiting illustrative example, a first trend and second trend can include two trends associated with the same time period, and the first trend and second trend can both describe changes in the same content analytics variable (e.g., number of impressions per day, etc.) during that time period. Continuing the non-limiting illustrative example, at least one of the first trend and second trend can be based on a subset of data values associated with the content analytics variable and time period, such as a subset determined based on a second content analytics variable (e.g., location subset determined based on a location variable, such as a trend in impressions attributable to viewers from Europe, etc.). In some instances, the first trend and second trend can both be based on subsets, or one of the first and second trend can be based on an entirety of a set of data values associated with the content analytics variable and time period. In some instances, a subset can be determined based on a plurality (e.g., two, three, four, etc.) of time series data 102 variables (e.g., content analytics variables). As a non-limiting illustrative example, a segment analysis may show that an identified trend is primarily driven by viewers ages 45-54 located in Dublin, Ireland. In the example, the data subset (people aged 45-54 in Dublin) associated with the segment analysis is determined based on two variables: viewer age and viewer location. In some instances, a segment analysis can include an analysis to identify one or more key drivers of an identified trend (e.g., data subsets that are responsible for a disproportionate share of a change associated with the trend, etc.).

In some instances, structured analysis can include a comparison between a first data value (e.g., statistical aggregate value such as rates, averages, etc., etc.) associated with the time series data 102 to another numerical value (e.g., expected value, range of expected values, threshold value such as an interestingness threshold, etc.). For example, in some instances, one or more trends in a time series data 102 variable (e.g., changes in the variable between a first time period and a second time period, etc.) can be compared to a threshold (e.g., relevance threshold, interestingness threshold), and provided as structured insight data 106 only if a magnitude of the trend (e.g., absolute value of percentage change between first time period and second time period, etc.) is greater than the threshold. As another example, in some instances, one or more first trends in a first time series data 102 variable can be compared to one or more second trends in a second time series data 102 variable. As a non-limiting illustrative example, a plurality of trends can be identified in a plurality of content analytics variables, and a top n (e.g., 2, 5, 10, 20, etc.) most interesting trends can be selected based on a numerical measure of interestingness or relevance. In some instances, a numerical measure of interestingness or relevance can include an absolute magnitude of each trend, and the top n largest changes can be selected (e.g., regardless of which variables are associated with the top n largest changes). In some instances, a numerical measure of interestingness or relevance can include a combined numerical value generated from a plurality of data values. For example, in some instances, a change in an important content analytics metric (e.g., conversion rate, etc.) may be treated as more interesting than a similar-size change in a less important content analytics metric (e.g., browsers used to view content items or related or connected content, etc.). As another example, a change may be treated as more interesting if it is relatively large compared to related changes, such as a corresponding change for related users, related data subsets, or the like. In some instances, generating a numerical measure of interestingness or relevance comprising a combined numerical value can include obtaining one or more magnitudes associated with one or more trends; obtaining one or more adjustment values (e.g., multipliers) associated with the one or more trends (e.g., relevance multiplier associated with a particular time series data 102 variable associated with the trend, such as cost per click, etc.); and generating a combined numerical value based on the magnitudes and the adjustment values (e.g., by multiplying magnitudes by multipliers, etc.).

In some instances, values generated or compared in a structured output can include raw time series data 102 values (e.g., content analytics values), or derived or aggregated values generated based on the raw time series data 102 values during the structured analysis. For example, in some instances, raw time series data 102 may include a plurality of data items showing a plurality of raw data values (e.g., impression counts, etc.) for a plurality of times (e.g., minutes, hours, etc.). In such instances, a derived value (e.g., impressions per day, etc.) can be generated by aggregating (e.g., summing, averaging, etc.) a plurality of raw data values. In other instances, a value of interest may be directly stored as time series data 102 (e.g., impression counts for a plurality of days if impressions per day is a value of interest; precomputed aggregate values stored directly as time series data 102 after precomputation; etc.).

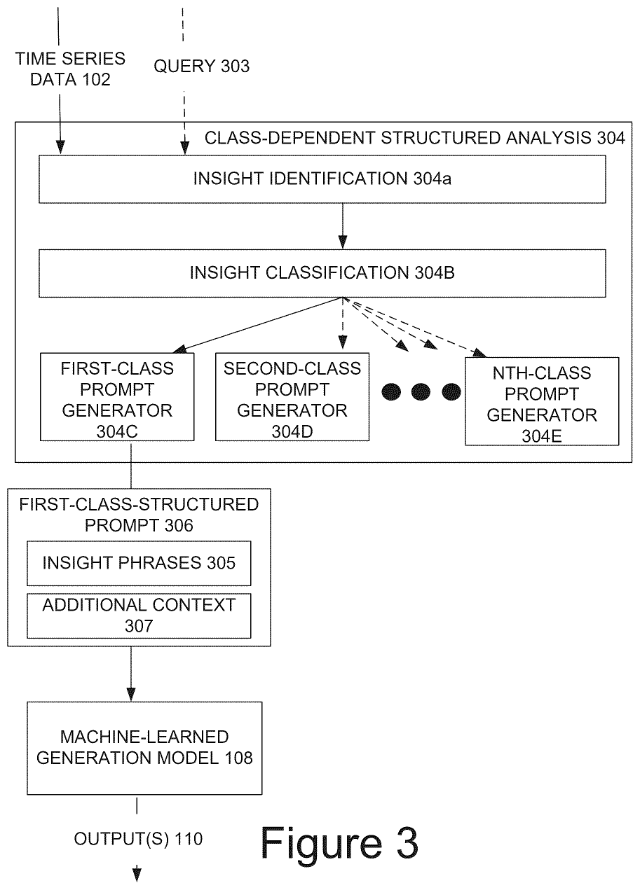

Structured data 106 can include, for example, one or more data items in a structured format. In some instances, structured data 106 can include data items correlating numerical data derived from the time series data 102 (e.g., trends, percentages, counts, rates, aggregate statistical data associated with a plurality of content interactions, etc.) with one or more other data values, such as content analytics data values associated with the times series data 102 from which the numerical data was derived. The one or more other data values can include, for example, metadata such as numerical, binary, or text data indicative of a data category associated with the numerical data (e.g., category name such as clickthrough rate, number of impressions, etc.; category identification number; etc.); a data segment (e.g., subset of the time series data 102 such as demographic segment, product segment, etc.) associated with the numerical data; or other data associated with the numerical data (e.g., website URL, product name or description, other content analytics data, etc.). As an illustrative example, structured insight data 106 identifying a recent change in clickthrough rate can include mathematical data describing the change (e.g., magnitude of the change, etc.); time data indicating one or more time periods associated with the change; and data identifying clickthrough rate as the content analytics variable that has changed. In some instances, structure data 106 can include natural language data in a structured format, such as one or more natural language phrases comprising a numerical value and a natural language description associated with the numerical value (e.g., “Month-to-month increase: 8 percent”; “Number of daily active users: 837”; etc.). Further details of some example structured insight data 106 comprising natural language content are provided below with respect to FIG. 3.

Data items in a structured format can include, for example, data objects (e.g., associated with an object-oriented programming language, etc.) or data structures (e.g., structs in a C programming language and the like); database rows or spreadsheet rows; data in a structured text format, such as a data object notation format (e.g., Javascript Object Notation (JSON) format), markup language format (e.g., extensible markup language (XML) format, hypertext markup language (HTML) format, etc.), or other structured format (e.g., comma-separated value (CSV) format, etc.); ordered tuplets or other data formatted according to a predefined order or arrangement; structured format associated with a communication protocol or data storage protocol; files comprising data in a structured format; or other structured data.

Structured data 106 can include one type or many types of data. Example data types for the structured data 106 can include any type of computer-readable data, such as numerical data, binary data, text data, structured data (e.g., XML, JSON, HTML, etc.), or other computer-readable data type.

The machine-learned generation model 108 can include one or more machine-learned models. The machine-learned generation model 108 can include various model architectures, such as various neural network model architectures. An example model architecture for a machine-learned generation model 108 can include a sequence processing model architecture (e.g., a transformer model). For example, the machine-learned generation model 108 can be configured to receive an input sequence and generate an output sequence. For instance, the machine-learned generation model 108 can be configured to generate an output sequence where elements of the output sequence are predicted based on the elements of the input sequence. In some instances, a machine-learned generation model 108 can include a generative language model (e.g., natural language model). In some instances, a machine-learned generation model 108 can include a model architecture having an attention mechanism (e.g., self-attention). In some instances, the machine-learned generation model 108 can be a pre-trained model (e.g., pretrained using large-scale unsupervised learning). In some instances, the machine-learned generation model 108 can be fine-tuned over one or more fine-tuning datasets, such as a fine-tuning dataset associated with an insight summarization task. For example, a fine-tuning dataset can include a dataset comprising input/output pairs comprising a structured data input (e.g., structured insight data 106, etc.) and a corresponding output (e.g., insight summary output; human-approved or human-generated output; output associated with a high evaluation score from a machine-learned evaluation model; etc.). As another example, a fine-tuning dataset can include a dataset comprising feedback data (e.g., user feedback data) associated with past insight summaries (e.g., human-written insight summaries, machine-generated insight summaries, etc.) that have been rated by users (e.g., thumbs up/down, numerical rating, etc.).

Outputs 110 can generally include one type or many types of data. In some instances, outputs 110 can include sequence data, such as text sequence data. In some instances, outputs 110 can include data in a natural language format (e.g., English text, French audio, etc.).

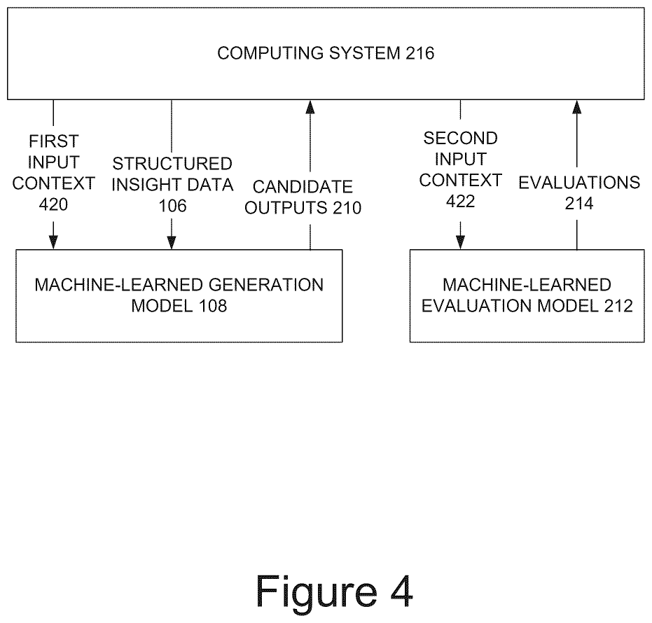

In some instances, outputs 110 can include one or more of: a title; a summary (e.g., natural language summary) of a structured insight data 106 item; and a segment analysis (e.g., natural language segment analysis) associated with the structured insight data 106 item. In some instances, generating an output 110 comprising two or more of a title, a summary, and a segment analysis can include performing one machine-learned inference to generate one output sequence based on one input sequence, or can include performing multiple machine-learned inferences based on multiple input sequences. In some instances, generating an output sequence based on an input sequence can include obtaining structured insight data 106; providing, to a machine-learned generation model 108, an input sequence comprising the structured insight data 106; and generating, by the machine-learned generation model 108 based on the input sequence, an output 110. In some instances, an input sequence can include other input context in addition to structured insight data 106, such as instruction context; prompt context such as many-shot or few-shot prompts; general knowledge context such as content analytics knowledge; or other appropriate input context. Example details of example input sequences for generating outputs 110 (e.g., outputs 110 comprising a title, a summary, and a segment analysis, etc.) are further provided below with respect to FIG. 4.

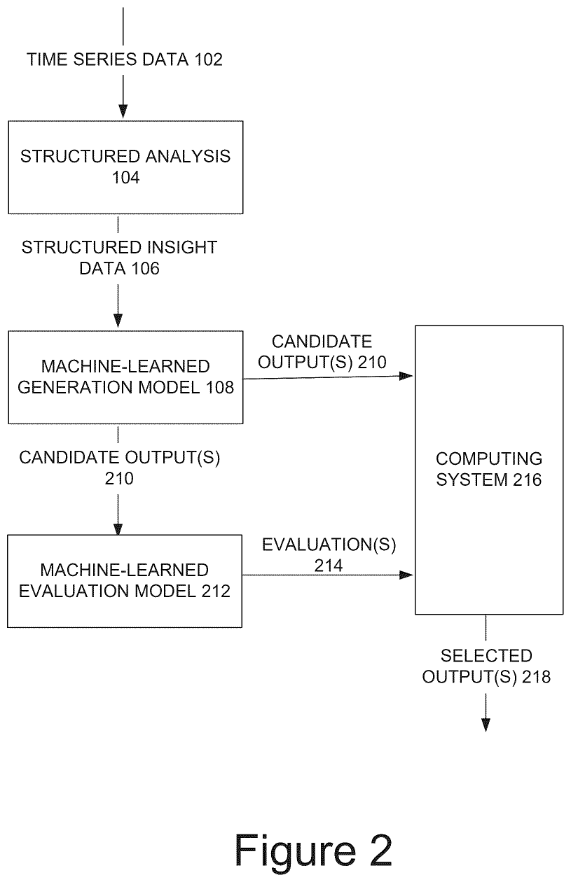

FIG. 2 depicts a block diagram of an example system for machine-learned insight summarization according to example aspects of the present disclosure. A structured analysis system 104 can process time series data 102 to generate structured insight data 106. The structured insight data 106 can be provided to a machine-learned generation model 108, which can generate one or more candidate output(s) 210 based on the structured insight data 106. A machine-learned evaluation model 212 can evaluate the candidate outputs 210 to generate one or more evaluation(s) 214. Based on the evaluation(s) 214, a computing system 216 can select zero or more selected output(s) 218 from the candidate output(s) 210, and can output the selected output(s) 218 (e.g., to a user).

In some instances, a candidate output 210 can be, comprise, be comprised by, or otherwise share one or more properties with an output 110. For example, in some instances, a candidate output 210 can have any property described herein with respect to an output 110, and vice versa.

The machine-learned evaluation model 212 can include one or more machine-

learned models. The machine-learned evaluation model 212 can include various model architectures, such as various neural network model architectures. An example model architecture for a machine-learned evaluation model 212 can include a sequence processing model architecture (e.g., a transformer model, sentence embedding model, etc.). For example, the machine-learned generation model 108 can be configured to receive an input sequence and generate one or more outputs (e.g., numerical evaluation score outputs, etc.) based on the input sequence. For instance, the machine-learned evaluation model 212 can be configured to generate one or more evaluation scores, where each evaluation score is predicted based on elements of an input sequence. In some instances, a machine-learned evaluation model 212 can include a language processing component (e.g., natural language processing). For example, in some instances, a machine-learned evaluation model 212 can include a first plurality of model layers (e.g., neural network layers, transformer layers, sentence embedding layers, etc.) configured to receive a natural language sequence as input and generate a machine-learned embedding as output; and one or more second model layers or model heads configured to receive a machine-learned embedding as input and generate one or more evaluation scores as output (e.g., readability score, actionability score, accuracy or support score, etc.). A machine-learned model head can be, for example, a machine-learned model component comprising one or more layers, wherein the head is arranged in parallel with another head of the machine-learned model. For example, a machine-learned evaluation model 212 can include a first plurality of layers configured to generate a machine-learned semantic embedding of a candidate output; a first evaluation “head” in series with the first plurality of layers configured to generate a first evaluation score (e.g., readability score, etc.) based on the semantic embedding; and a second evaluation “head” in series with the first plurality of layers and in parallel with the first evaluation “head,” wherein the second evaluation “head” can be configured to generate a second evaluation score (e.g., actionability score, etc.) based on the semantic embedding. A second layer or evaluation head can include, for example, any model architecture configured to generate a machine-learned evaluation (e.g., numerical score) based on a machine-learned embedding (e.g., multilayer perceptron architecture, regression model architecture such as logistic regression or softmax regression, classification model architecture, etc.).

In some instances, a machine-learned evaluation model 212 can include an embedding architecture (e.g., sentence embedding architecture) configured to output one or more machine-learned embeddings, and an accuracy score (e.g., entailment score, factual support score, similarity score, etc.) can be determined based on a comparison between a first embedding generated by the machine-learned evaluation model 212 based on a candidate output 210 and a second embedding generated by the machine-learned model 212 based on structured insight data 106. For example, in some instances, an accuracy score can be based at least in part on a similarity metric (e.g., distance metric such as Euclidean distance, cosine distance, etc.) comparing the first embedding and second embedding. Other implementations are possible.

In some instances, a machine-learned evaluation model 212 can include a model architecture having an attention mechanism (e.g., self-attention). In some instances, the machine-learned evaluation model 212 can be or include a pre-trained model component (e.g., pretrained using large-scale unsupervised learning). In some instances, the machine-learned evaluation model 212 can be fine-tuned over one or more fine-tuning datasets, such as a fine-tuning dataset associated with an insight summarization task. For example, a fine-tuning dataset can include a dataset comprising input/output pairs comprising a structured data input (e.g., structured insight data 106, etc.) and a corresponding evaluation output (e.g., evaluation score output, etc.). As another example, a fine-tuning dataset can include a dataset comprising feedback data (e.g., user feedback data) associated with past insight summaries (e.g., human-written insight summaries, machine-generated insight summaries, etc.) that have been rated by users (e.g., thumbs up/down, numerical rating, etc.).

Evaluations 214 can generally include one type or many types of data (e.g., numerical, binary, text, structured data, etc.). In some instances, evaluations 214 can include one or more numerical evaluation scores (e.g., readability score, actionability score, accuracy score, predicted user feedback score, etc.). In some instances, a numerical evaluation score can include a numerical score indicative of a degree to which structured insight data 106 provides factual support to one or more factual claims (e.g., mathematical claims, etc.) contained in a candidate output 210 generated based on the structured insight data 106. In other words, a numerical evaluation score can include a score indicating whether the candidate output 210 accurately reflects factual content of the structured insight data 106, without adding any factual content that is not contained in the structured insight data 106. In some instances, evaluations 214 can include evaluations in one or more other data formats (e.g., Boolean format such as good/bad, yes/no, true/false, supported/unsupported, etc.; natural language data providing a natural language evaluation or a natural language reasoning associated with an evaluation; etc.).

Generating an evaluation 214 can include providing an input to the machine-learned evaluation model 212; and generating, using the machine-learned evaluation model 212 based on the input, one or more outputs comprising one or more evaluations 214. Example details of example inputs for generating an evaluation 214 are further provided below with respect to FIG. 4.

A computing system 216 can be or include one or more, firmware, or hardware components configured to process candidate output(s) 210 and evaluation(s) 214, and to select selected output(s) 218 based on the candidate output(s) 210 and evaluation(s) 214. In some instances, the computing system 216 can be, comprise, be comprised by, or share one or more properties with a computing device or system described below with respect to FIGS. 9A-9C (e.g., server computing system 930, training computing system 950, computing device 10, computing device 50, etc.).

A selected output 218 can be, comprise, be comprised by, or otherwise share one or more properties with a candidate output 210. For example, a selected output 218 can have any property described herein with respect to a candidate output 210. A selected output 218 can include, for example, a candidate output 210 that was selected by the computing system 216 for output (e.g., for display to a user, etc.).

Selecting the selected output(s) 218 can include, for example, selecting based on a numerical comparison of one or more numerical evaluation 214 scores. For example, selecting the selected output(s) 218 can include comparing one or more numerical evaluation 214 scores (e.g., readability scores, actionability scores, accuracy or support scores, combined score generated based on a plurality of evaluation 214 subscores, etc.) to one or more numerical thresholds. As another example, selecting the selected output(s) 218 can include comparing a plurality of numerical evaluation 214 scores to each other (e.g., by selecting n highest-scoring candidate outputs 210, wherein n can be one, two, etc.). In some instances, selecting the selected output(s) 218 can include both a threshold comparison and an inter-output comparison. For example, a top n (e.g., one) candidate outputs 210 can be identified, and an evaluation 214 score of the top n candidate outputs 210 can be compared to a threshold (e.g., minimum evaluation score threshold, etc.). If one or more of the top n evaluation 214 scores are below the threshold, a computing system 216 may choose not to select the candidate outputs 210 having a score below the threshold (e.g., by selecting zero selected output(s) 218, such that a user is not provided with any of the candidate outputs 210). In some instances, selecting the selected output(s) 218 can include comparisons to multiple separate thresholds (e.g., readability score threshold, actionability score threshold, accuracy score threshold, etc.) or to a single threshold such as a combined threshold associated with a combined evaluation 214 score. In some instances, a combined evaluation 214 score can include a mathematical combination (e.g., arithmetic combination such as weighted average, etc.) of two or more evaluation 214 subscores.

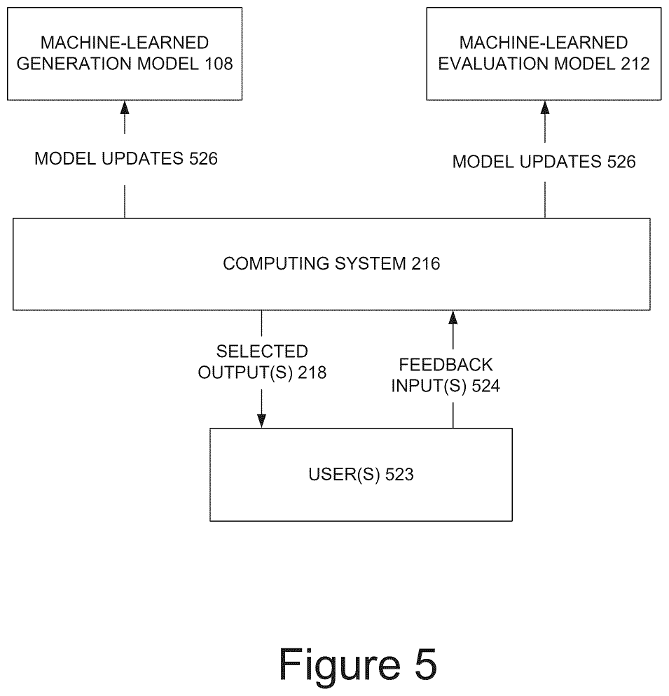

In some instances, the selected output(s) 218 can be provided alongside one or more user interface elements (e.g., graphical user interface elements), such as a user interface component for providing feedback evaluating the selected output(s) 218 (e.g., thumbs up/down interface component, etc.); a user interface component for displaying a chart associated with the selected output(s) 218, such as a chart for displaying the structured insight data 106 used to generate the selected output(s) 218 or associated time series data 102 used to generate the structured insight data 106; a user interface component configured to cause the chart to be filtered according to a segment analysis when the interface component is interacted with by the user (e.g., “Filter by Key Drivers” button, etc.); general user interface components associated with a content analytics user interface; or other interface components. Example details of example segment analyses are further provided below with respect to FIG. 4. Example details of example user feedback functions are further provided below with respect to FIG. 5.

FIG. 3 depicts a block diagram of an example system for machine-learned insight summarization according to example aspects of the present disclosure. A class-dependent structured analysis system 304 can process time series data 102 to generate a structured prompt 306 having a class-dependent structured format. In some instances, the processing can be based at least in part on a query 303 (e.g., user query asking a question about the time series data 102, etc.). The class-dependent structured analysis system 304 can include an insight identification system 304a to identify one or more mathematical insights (e.g., mathematical properties of interest, mathematical insights responsive to a query 303, etc.) in the time series data 102. The class-dependent structured analysis system 304 can include an insight classification system 304b to classify the identified insight(s) into one or more insight classes (e.g., one of N insight classes). Based on the classification, one of a plurality of class-specific prompt generators 304c-e can generate a class-structured prompt 306, and the machine-learned model 108 can generate one or more outputs based on the class-structured prompt 306. In some instances, a class-structured prompt 306 can include insight phrases 305 comprising natural language phrases associated with an insight identified by the insight identification system 304a. In some instances, a class-structured prompt 306 can include additional context 307, such as an optimized prompt or prompt template comprising one or more of instruction content describing one or more output requirements for the class, few-shot prompt content comprising one or more example input-output pairs associated with the class, or other content.

A query 303 can include, for example, an input (e.g., natural language input, categorical input, numerical input, binary input, etc.) to an insight identification system 304a on which an insight identification can be based. For example, in some instances, a query 303 can include a natural language input describing or otherwise indicative of one or more properties of an insight to be identified, such as an insight category (e.g., increase, decrease, surprise, segment insight, etc.); a metric associated with the insight (e.g., number of users, clickthrough rate, etc.); or other property. For example, in some instances, a query 303 can include a question or other natural language input (e.g., statement, phrase, keyword, etc.) requesting identification of a particular type of insight (e.g., “How many users did I have last week?”; “Please analyze trends in user ages for my website.”; “demographic trends”; etc.). In some instances, a query 303 can include categorical data indicative of one or more insight properties, such as selection data indicative of a user selection of one or more insight properties (e.g., metric, time period, insight category, segment, filters, etc.). In some instances, a query 303 can include filter data indicative of one or more subsets of the time series data 102, and the insight identification system 304a can identify insights (e.g., mathematical relationships, etc.) associated with the one or more subsets. In some instances, a query 303 can include an input received from a user.

In some instances, a class-dependent structured analysis system 304 can be, comprise, be comprised by, or otherwise share one or more properties with a structured analysis system 104. For example, in some instances, a class-dependent structured analysis system 304 can have any property described herein with respect to a structured analysis system 104, and vice versa. As another example, in some instances, an insight identification system 304a can perform any action described herein with respect to performing a structured analysis to identify insights, and vice versa; and the remainder of the class-dependent structured analysis system 304 (e.g., insight classification 304b, class-specific prompt generators 304c-e, etc.) can perform any action described herein with respect to generating structured insight data 106 based on an identified insight, and vice versa.

An insight identification system 304a can include, for example, one or more software, firmware, or hardware components configured to process time series data 102 to identify one or more insights (e.g., mathematical relationships, etc.) associated with the time series data 102 (e.g., based on a query 303, not based on a query 303, etc.). In some instances, the insight identification system 304a can be, comprise, be comprised by, or share one or more properties with a computing device or system described below with respect to FIGS. 9A-9C (e.g., server computing system 930, training computing system 950, computing device 10, computing device 50, etc.).

An insight classification system 304b can include, for example, one or more software, firmware, or hardware components configured to process an insight identification received from an insight identification system 304a to determine a classification (e.g., mathematical relationship class, insight class, etc.) associated with the insight identification. In some instances, the insight classification system 304b can be, comprise, be comprised by, or share one or more properties with a computing device or system described below with respect to FIGS. 9A-9C (e.g., server computing system 930, training computing system 950, computing device 10, computing device 50, etc.).

In some instances, insight classification system 304b or class-dependent structured analysis system 304 can determine an insight classification in any appropriate manner. For example, in some instances, an insight identification system 304a can output insight data comprising classification data indicative of a class of mathematical relationships to which an insight belongs. As a non-limiting illustrative example, the insight identification system 304a may output a data structure (e.g., object of an object-oriented programming language, database row, struct, etc.) comprising data indicative of an insight generated from the time series data 102. Continuing the non-limiting illustrative example, in some instances, the data structure can include one or more properties (e.g., class associated with an object-oriented programming object instance; parameter value, field value, data entry value, column value, or other value stored in the data structure; etc.) indicative of a class associated with the insight. For example, in some instances, an insight identification system 304a can include a plurality of components (e.g., modules, subroutines, loops, code segments, etc.) associated respectively with a plurality of mathematical relationship classes, and each component can be configured to identify one or more insights associated with time series data 102 and generate one or more data structures indicative of the insights, the data structures comprising data indicative of a corresponding mathematical relationship class associated with each insight.

As another example, in some instances, an insight classification system 304b can parse (e.g., using a regular expression, etc.) or otherwise process an insight identification output (e.g., natural language output, numerical output, binary output, structured output such as XML-structured or JSON-structured output, etc.) to determine a class associated with the output. In some instances, an insight classification system 304b can determine a mathematical relationship class according to one or more rules (e.g., deterministic rules, binary decision tree, if/then/else rules, etc.). As a non-limiting illustrative example, an insight classification system 304b can identify an insight class (e.g., mathematical relationship class, etc.) by applying a binary decision tree (e.g., binary decision tree implemented using if/then/else programming logic, etc.) to one or more properties of an identified insight; time series data 102 or subset associated with the identified insight; or other data. For example, a property of an identified insight can include the existence or nonexistence of one or more comparisons or types of comparisons (e.g., temporal comparisons, physical distance comparisons, demographic comparisons such as age comparisons, etc.); a number or type of data entries associated with the identified insight (e.g., single value vs. multiple value, time series data vs. single-time-window data, etc.). In some instances, a property of a subset of time series data 102 can include a number and type of data segments associated with the subset.

As another example, in some instances, an insight classification system 304b can include one or more machine-learned models, and can perform a machine-learned insight classification. For example, in some instances, a query 303 (e.g., natural language query, etc.) can be provided to a machine-learned model (e.g., language model, etc.), and the machine-learned model can determine an insight class based on the query 303. Other implementations are possible.

In some instances, determining an insight classification can include selecting a class from a plurality of available insight classes (e.g., based on one or more properties of a mathematical insight). In some instances, a plurality of available classes can include one or more groups of mathematical relationships that can be processed using one or more common components (e.g., common data structures, common software modules, common code segments, common structured prompt formats, etc.). For example, in some instances, a boundary between classes of mathematical relationships can be defined at least in part by a machine-learned model's ability to process different members of a class using a common structure. As a non-limiting illustrative example, a machine-learned model may be better able to accurately generate outputs describing mathematical relationships with temporal components if it receives an input comprising natural language content (e.g., “earlier,” “later,” “before,” “after,” etc.) describing the temporal components in natural language. Continuing the non-limiting illustrative example, the machine-learned model may generate higher-quality outputs describing non-temporal relationships if its inputs lack temporal natural language content. In such an example, a plurality of mathematical relationships can be divided into classes based at least in part on the existence or nonexistence of a temporal component to the relationships. Other divisions are possible (e.g., presence or absence of spatial component such as “near” or “far,” number of segments or segment dimensions of a metric being measured, etc.).

In some instances, an example set of relationship classes can include one or more (e.g., all) of a single-numerical-value class (e.g., number of users in the past week), a class comprising comparisons between single values (e.g., “How many users this week compared to last week?”), a multiple-numerical-value class (e.g., number of users in the past week, broken down by device), a multiple-value-with-comparison class (e.g., number of users this week compared to last week, broken down by browser), a single-property time series class (e.g., trends in user count over the past month), and a multiple-property time series class (e.g., trends in user count over the past month, broken down by device, etc.).

In some instances, a class-dependent structured analysis system 304 can route, based at least in part on an insight classification, insight data (e.g., insight data determined by an insight identification system 304a, etc.) to a class-specific prompt generator 304a-c associated with the insight class. In some instances, the class-specific prompt generator can generate a structured prompt 306 having a class-specific prompt structure. For example, as depicted in FIG. 3, an insight classification system 304b can determine that an identified insight belongs to a first insight class (e.g., mathematical relationship class such as comparison between single values, etc.); the class-dependent structured analysis 304 can provide, responsive to the determination, insight identification data to the first-class prompt generator 304c; and the first-class prompt generator 304c can generate a first-class-structured prompt 306 based on the insight identification data.

A class-specific prompt generator 304c-e can include, for example, one or more software, firmware, or hardware components configured to process insight identification data to generate a class-dependent structured prompt 306. In some instances, the class-specific prompt generator 304c-e can be, comprise, be comprised by, or share one or more properties with a computing device or system described below with respect to FIGS. 9A-9C (e.g., server computing system 930, training computing system 950, computing device 10, computing device 50, etc.). In some instances, the class-specific prompt generator 304c-e can be associated with a computing device that is the same as or different from a computing device associated with an insight identification system 304a, insight classification system 304b, computing system 216, or other device.

Insight phrases 305 can include, for example, one or more phrases (e.g., natural language phrases, etc.) indicative of one or more insights (e.g., mathematical relationships, trends, etc.) identified by a class-dependent structured analysis system 304 based on time series data 102. For example, in some instances, insight phrases 305 can include natural language phrases describing one or more aspects of the time series data 102 or insight data in a format that a machine-learned model 108 can process reliably (e.g., natural language format, structured format, structured natural language format, etc.)

In some instances, a class-specific prompt generator 304c-e can include one or more components configured to generate insight phrases 305 (e.g., natural language phrases) based at least in part on raw time series data 102 or raw numerical data received from an insight identification system 304a. For example, in some instances, a class-specific prompt generator 304c-e can include a class-specific preprocessor that maps (e.g., according to a class-specific mapping) numerical data (e.g., numerical insight data, time series data 102, etc.) to corresponding natural language phrases describing the numerical data in a format the machine-learned generation model 108 can understand. In some instances, a class-specific preprocessor can include one or more software, firmware, or hardware components configured to extract one or more values of interest (e.g., highest value, lowest value, percent change, etc.) from numerical data, and output one or more corresponding natural language phrases associated with the values of interest. In some instances, generating a corresponding natural language phrase can include concatenating one or more values of interest to one or more predetermined natural language phrases. As a non-limiting illustrative example, a class-specific preprocessor associated with an insight class associated with changes in time series data over time can include a function to extract a highest value over a period of time and append the highest value to a natural language phrase such as “Highest value:”. In some instances, a plurality of values of interest can be combined with a plurality of predetermined phrases (e.g., “Time granularity:”, “Time range:”, “Metric:”, “Dimension:”, “Highest value:”, “Second highest value:”, “Lowest value:”, “Percent increase:”, “Percent Decrease:”) to generate a plurality of natural language phrases (e.g., “Highest value:23,061.08 on November 4”, etc.). In some instances, a class-specific processor can map a value (e.g., numerical value, binary value, enum value, class value associated with an object-oriented language object, etc.) to a corresponding natural language value (e.g., text phrase, etc.) as part of a preprocessing step (e.g., before concatenating the natural language value with a predetermined phrase, etc.). As a non-limiting illustrative example, a class-specific preprocessor can map one or more non-textual values of interest (e.g., binary values, numerical values, datetime values, etc.) indicative of a time range (e.g., October 31 through November 13, etc.) to a corresponding natural language phrase describing the time range (e.g., “last two weeks”, etc.) and can concatenate the mapped value with a predetermined phrase associated with the values of interest (e.g., “Time Range:”, etc.). In some instances, mapping numerical data to corresponding natural language phrases can include concatenating one or more natural language segments (e.g., sentences, phrases, etc.) according to one or more rules (e.g., according to a binary decision tree, etc.). For example, in some instances, mapping numerical data to corresponding natural language phrases can include identifying the existence or non-existence of one or more patterns (e.g., daily cycles, weekly cycles, mathematical relationships between variables, etc.) in the data and including or not including, based on the identification, natural language phrases associated with the patterns. As a non-limiting illustrative example, a rule can include adding the sentence “Values fluctuated” if a mathematical analysis determines that a time series includes values that have risen and fallen more than N times (e.g., twice, four times, etc.) in a given time period. Continuing the example, a rule can include adding the sentence “Values rose steadily” if a time series includes a large number of increases with few or no decreases between consecutive time steps. As another example, a rule can include adding the sentence “The highest value is nearly X% more than the second highest” if the relevant percentage is above a threshold, and omitting the sentence if the relevant percentage is below the threshold. Other rules are possible.

In some instances, a class-specific prompt generator 304c-e can include complex or simple logic, and a number of insight phrases 305 generated by the class-specific prompt generator 304c-e can be large or small depending on the relevant insight class. As a non-limiting illustrative example, a class-specific prompt generator 304c-e associated with a single-value non-comparison insight class may extract a single value and add a single natural language phrase describing a duration of an observation period associated with the single value (e.g., “Time period: One week; Number of users: 237”, etc.). As another example, a class-specific prompt generator 304c-e associated with a segmented comparison between pairs of time series (e.g., “Compare trends in user traffic this week to trends in user traffic last week, segmented by device”, etc.) may require more complex logic and may generate a larger number of insight phrases 305.

In some instances, a class-specific prompt generator 304c-e can include one or more components configured to retrieve or otherwise determine one or more additional context 307 items. For example, in some instances, a class-specific prompt generator 304c-e can retrieve, from a data structure (e.g., database, file, data object, table, row, etc.), a predetermined additional context 307 value, such as a predetermined optimized few-shot prompt. In some instances, a class-specific prompt generator 304c-e can include one or more components configured to build (e.g., modularly build, etc.) the additional context 307 based on one or more properties of an identified insight. As a non-limiting illustrative example, a rule can include adding an example input-output pair associated with fluctuating time series values if an identified insight is associated with one or more values that have fluctuated over time, and omitting the example input-output pair if not. Other rules are possible.

Additional context 307 can include, for example, a class-specific base prompt that has been engineered to provide optimal machine-learned inference results when paired with insight phrases 305 generated by a class-specific prompt generator 304c-e associated with the same class and provided to a machine-learned model 108. In some instances, additional context 307 can include instruction content, such as natural language content describing one or more output requirements to be satisfied (e.g., “Please write a paragraph summarizing the following data and explaining why it is interesting. The paragraph should be no more than four sentences long.” etc.) or otherwise providing instruction to the machine-learned model 108. In some instances, additional context 307 can include few-shot prompt content, such as one or more example input-output pairs. For example, an input-output pair can include an example input comprising an example set of insight phrases 305, and a corresponding example output associated with the example set of insight phrases 305, such as an optimal (e.g., error-free, human-written, etc.) insight summary describing the data associated with the insight phrases 305 in natural language (e.g., in paragraph form, etc.). In some instances, additional context 307 can include chain-of-thought prompt content, such as one or more input-intermediate value-output triplets. An input-intermediate value-output triplet can include, for example, an input comprising an example set of insight phrases 305; one or more intermediate values, such as intermediate values comprising an example “thought process” or set of intermediate steps to arrive at an optimal output; and an example output, such as an example natural language insight summary.

In some instances, the additional context 307 can be optimized based on one or more training examples, user feedback, or other training data. For example, in some instances, a computing system can obtain a plurality of class-specific candidate prompts or components thereof (e.g., candidate input-output pairs, candidate input-intermediate thought-output triplets, candidate instruction content or “preamble” content). In some instances, the computing system can test the plurality of candidate prompts, or test a plurality of combinations of candidate prompt components, and select a best prompt out of the plurality of prompts tested. For example, in some instances, a computing system can generate a plurality of outputs 110 based on different candidate prompts, and can provide the outputs 110 to one or more users. The computing system can then receive feedback indicative of an output quality of each output 110 from the users, and can select between the plurality of candidate prompts based on the feedback. As another example, in some instances, a computing system can obtain a training dataset comprising a plurality of input-output pairs (e.g., optimal input-output pairs, human-written input-output pairs, human-annotated input-output pairs, etc.) and, for each candidate prompt being tested: provide, to the machine-learned model 108, a plurality of prompts comprising the candidate prompt and an input of an input-output pair; generate, using the machine-learned model 108, an inference output; and compare the inference output to an output (e.g., optimal output, etc.) of the input-output pair (e.g., according to a loss function, similarity metric such as edit distance, etc.). Based on the comparisons, the computing system can determine which of the candidate prompts is associated with the highest quality output, and can use the best candidate prompt as class-specific additional context 307.

In some instances, the additional context 307 or first-class prompt generator 304c can be improved over time, such as in response to one or more flaws (e.g., factual errors, hallucinations, other quality flaws such as readability or actionability flaws, etc.) identified in one or more outputs 110. For example, in some instances, if a machine-learned generation model 108 generates an erroneous output in relation to a particular set of time series data 102 or insight phrases 305 or in relation to a particular query 303, alternative insight phrases 305 or alternative additional context 307 can be tested in relation to the same query 303 and time series data 102. In some instances, if adding an additional insight phrase 305 to a set of insight phrases 305 causes the machine-learned generation model 108 to generate an accurate output 110 based on the same time series data 102 or query 303, then a class-specific prompt generator 304c-e can be updated to cause the class-specific prompt generator 304c-e to include the additional insight phrase 305 in future sets of insight phrases 305. Additionally or alternatively, in some instances, a new class of insights can be defined, and an additional class-specific prompt generator 304c-e can be created, wherein the additional class-specific prompt generator 304c-e is configured to include the additional insight phrase 305 in future sets of insight phrases 305. For example, if adding the additional insight phrase 305 harms a performance quality (e.g., accuracy, readability, actionability, etc.) of the machine-learned model 108 or outputs 110 with respect to some queries 303 or sets of time series data 102, and improves the performance quality with respect to some queries 303 or sets of time series data 102, then an existing class can be split into two or more classes to facilitate inclusion of the additional insight phrase 305 when it may be helpful, and omission of the additional insight phrase 305 when it may be unhelpful.

In some instances, additional context 307 can include one or more components described herein with respect to structured insight data 106 or other inputs for a machine-learned model 108 described herein. For example, in some instances, additional context 307 can have one or more properties or components described below with respect to FIG. 4 and first input context 420.

In some instances, a first-class-structured prompt 306 can be, comprise, be comprised by, or otherwise share one or more properties with structured insight data 106. For example, in some instances, a first-class-structured prompt 306 can have any property described herein with respect to structured insight data 106, and vice versa. In some instances, a first-class-structured prompt 306 or other class-specific structured prompt can have a format (e.g., structure, arrangement, etc.) that is specific to a class of mathematical relationships (e.g., class associated with a class-specific prompt generator 304c-e that generated the class-specific structured prompt, etc.). In some instances, a first-class structured prompt 306 can include a combination of insight phrases 305 (e.g., insight phrases having a class-specific structure or format associated with a first class of mathematical relationships, etc.) and additional context 307. For example, in some instances, insight phrases 305 can be concatenated with (e.g., appended to the beginning or end of, etc.), interleaved with, or otherwise combined with the additional context 307 to generate a full first-class-structured prompt 306. The first-class-structured prompt 306 can then be provided to the machine-learned generation model 108, and the machine-learned generation model 108 can generate outputs 110 based on the first-class-structured prompt 306.

FIG. 4 depicts an example system for machine-learned insight summarization according to example aspects of the present disclosure. A computing system 216 can provide first input context 420 to a machine-learned generation model 108. The first input context 420 may include or be accompanied by structured insight data 106. Based on the first input context 420 and structured insight data 106, the machine-learned generation model can generate candidate outputs 210. The computing system 216 can provide second input context 422 to the machine-learned evaluation model 212, which may include or be accompanied by candidate outputs 210. Based on the second input context 422, the machine-learned evaluation model 212 can generate evaluations 214.

First input context 420 can include, for example, any input context configured to be provided to a machine-learned generation model 108 to cause the machine-learned generation model 108 to generate candidate output(s) 210. In some instances, first input context 420 can include one or more input sequences, such as language sequences (e.g., natural language sequences such as text, audio, etc.). In some instances, first input context 420 can include or be accompanied by structured insight data 106, such as structured insight data 106 describing a trend; a segment analysis (e.g., segment analysis associated with the trend); or other insight (e.g., content analytics insight).

In some instances, first input context 420 can include one or more fill-in-the-blank templates indicative of one or more output formats for a candidate output 210. In some instances, first input context 420 can include one fill-in-the-blank template, or multiple fill-in-the-blank templates (e.g., with an instruction for the machine-learned generation model 108 to select the most appropriate fill-in-the-blank template for summarizing or otherwise describing the structured insight data 106). In some instances, a fill-in-the-blank template can include one or more of a title portion, a summary portion, and a segment analysis portion.

A title portion of a fill-in-the-blank template can include, for example, a fill-in-the-blank template portion configured to cause the machine-learned generation model 108 to generate a title for inclusion in a candidate output 210. In some instances, a title portion can include a placeholder (e.g., tag such as “<TITLE_GOES_HERE>”, “{insight-variable}”, etc.), delimiter (e.g., “Title:”, “#T#”, etc.), or other marker for identifying a place where a title or title portion should be added (i.e., where a “blank” should be filled in) by the machine-learned generation model 108. In some instances, a title portion of a fill-in-the-blank template can include one or more “filled in” portions comprising data for the machine-learned generation model 108 to include in the title unmodified. In some instances, the filled in portions can be determined based at least in part on the structured insight data 106 (e.g., according to a deterministic formula, etc.). As a non-limiting illustrative example, structured insight data 106 may include data indicative of a trend associated with a particular time period (e.g., last 24 hours, last seven days, etc.), time series data 102 variable (e.g., content analytics variable such as clickthrough rate, etc.), and other data. In such instances, an example template can include, by way of non-limiting example, a filled-in portion comprising one or more of the time period and the time series data 102 variable, along with zero or more “blank” (e.g., placeholder, delimiter, marker, etc.) portions (e.g., “Seven-day clickthrough rate trend: {SHORT_TREND_SUBTITLE}”, etc.).

A summary portion of a fill-in-the-blank template can include, for example, a fill-in-the-blank template portion configured to cause the machine-learned generation model 108 to generate a brief (e.g., one-sentence, three-sentence, one-paragraph, two-paragraph, etc.) summary of all or part of the structured insight data 106 (e.g., a trend identified by the structured insight data 106). In some instances, a summary portion of a fill-in-the-blank template can include a placeholder (e.g., tag such as “<SUMMARY_GOES_HERE>”, “{general-trend-overview}”, etc.), delimiter (e.g., “______”, “#SUMM#”, etc.), or other marker for identifying a place where a title or title portion should be added (i.e., where a “blank” should be filled in) by the machine-learned generation model 108. In some instances, a summary portion of a fill-in-the-blank template can include one or more “filled in” portions comprising data for the machine-learned generation model 108 to include in the summary unmodified (e.g., “In the past <TIME PERIOD>,” etc.). A “filled in” portion can include, for example, one or more sentences or partial sentences (e.g., phrases, clauses, individual words, etc.) to be included in a candidate output 210. In some instances, one or more filled-in portions can be determined based at least in part on the structured insight data 106 (e.g., according to a deterministic formula, etc.). As a non-limiting illustrative example, structured insight data 106 may include data indicative of a trend associated with a particular time period (e.g., last 24 hours, last seven days, etc.), time series data 102 variable (e.g., content analytics variable such as clickthrough rate, etc.), and other data. In such instances, an example template can include, by way of non-limiting example, a filled-in portion comprising one or more of the time period and the time series data 102 variable, along with zero or more “blank” (e.g., placeholder, delimiter, marker, etc.) portions (e.g., “In the past seven days, your clickthrough rates have ______.”, etc.).

A segment analysis portion of a fill-in-the-blank template can include, for example, a fill-in-the-blank template portion configured to cause the machine-learned generation model 108 to generate a brief (e.g., one-sentence, three-sentence, one-paragraph, two-paragraph, etc.) segment analysis based on segment analysis data of the structured insight data 106.

In some instances, a segment analysis portion of a fill-in-the-blank template can include a placeholder (e.g., tag such as “<SEGMENT_ANALYSIS_GOES_HERE>”, “{analyze-segments}”, etc.), delimiter (e.g., “Segment analysis:”, “#SEG#”, etc.), or other marker for identifying a place where a title or title portion should be added (i.e., where a “blank” should be filled in) by the machine-learned generation model 108. In some instances, a summary portion of a fill-in-the-blank template can include one or more “filled in” portions comprising data for the machine-learned generation model 108 to include in the summary unmodified (e.g., “This trend has been largely driven by”, etc.). A “filled in” portion can include, for example, one or more sentences or partial sentences (e.g., phrases, clauses, individual words, etc.) to be included in a candidate output 210. In some instances, one or more filled-in portions can be determined based at least in part on the structured insight data 106 (e.g., according to a deterministic formula, etc.). As a non-limiting illustrative example, structured insight data 106 may include data indicative of a segment analysis associated with a particular time period (e.g., last 24 hours, last seven days, etc.), time series data 102 variable (e.g., content analytics variable such as clickthrough rate, etc.) associated with a trend, and one or more second time series data 102 variables for dividing the trend data into segments. In such instances, an example template can include, by way of non-limiting example, a filled-in portion comprising one or more of the time period and the first or second time series data 102 variables, along with zero or more “blank” (e.g., placeholder, delimiter, marker, etc.) portions (e.g., “This change in your clickthrough rates has been primarily driven by <SUMMARIZE_KEY_DRIVERS>,” etc.).

In some instances, first input context 420 can include instruction content. In some instances, instruction content can include input context (e.g., natural language input context, etc.) describing one or more tasks for the machine-learned generation model 108 to perform (e.g., “Please summarize the following structured insight data:”, etc.). In some instances, the one or more tasks described can include generating a title for the candidate output 210; generating a summary of a trend in the structured insight data 106 to include in the candidate output 210; generating a segment analysis based on the structured insight data 106; filling in the blank(s) of a fill-in-the-blank output template; imitating one or more example outputs (i.e., generating a candidate output 210 configured to be similar to or analogous to the example outputs); intelligently explaining the relevance of the trend (e.g., based on general knowledge provided in the input context 420, such as content analytics knowledge); or other task.

In some instances, the first input context 420 can include one or more (e.g., a plurality of) example outputs (e.g., human-generated or human-approved example outputs, etc.). In some instances, the example outputs can be included in one or more input-output pairs. For example, an input-output pair can include an example input or partial input (e.g., structured insight data 106 identifying a trend or segment analysis, fill-in-the-blank template, etc.) and a corresponding example output generated (e.g., by a human, by a machine-learned generation model 108) based on the example input. In some instances, the input-output pairs can be selected for inclusion in a first input context 420 based at least in part on human feedback, such as user feedback associated with past selected outputs 218, etc. Example details of an example implementation for receiving user feedback are further provided below with respect to FIG. 5.

In some instances, the first input context 420 can include general knowledge context, such as natural language data indicative of general content analytics knowledge. In some instances, general knowledge context can include static context (e.g., context that is the same for all structured insight data 106, etc.) or dynamic context (e.g., dynamically generated, dynamically retrieved, etc.). For example, in some instances, general knowledge context can be retrieved (e.g., from a general knowledge data store, data structure, database such as vector database, etc.) based at least in part on structured insight data 106. For example, in some instances, a trend of the structured insight data 106 may be a trend associated with a first time series data 102 variable, and a segment analysis of the structured insight data 106 may include segments defined based on one or more second time series data 102 variables. In such instances, a computing system 216 can retrieve general knowledge data associated with the first or second time series data 102 variables, and include the retrieved general knowledge data in the first input context 420.

The second input context 422 can include, for example, a candidate output 210 to be evaluated. In some instances, the second input context 422 can include other input context, such as the structured insight data 106 used to generate the candidate output 210. In some instances, the second input context 422 can include or not include instruction content (e.g., natural language instruction content); example input-output pairs (e.g., pairs of candidate output 210 inputs and readability or actionability score outputs; pairs of inputs comprising candidate outputs 210 and corresponding structured insight data 106, with corresponding accuracy score output; etc.); general knowledge data; or other natural language context. For example, in some instances, a machine-learned evaluation model 212 can include a model specially trained (e.g., based on training data comprising candidate output 210-evaluation 214 pairs) to generate an evaluation 214 output based on a candidate output 210 input or an input comprising a candidate output 210 and corresponding structured insight data 106. In such instances, an input to the model might not include any instruction content, input-output pairs, or the like.

FIG. 5 depicts a block diagram of an example system for training machine-learned models 108, 212 based on user feedback. A computing system can provide one or more selected output(s) 218 to one or more user(s) 522, along with a mechanism for the user 523 to provide feedback input(s) 524. Responsive to receiving one or more feedback input(s) 524 from the user(s) 523, the computing system can provide model updates 526 to the machine-learned models 108, 212. In some instances, the activities depicted in FIG. 5 can be repeated for a plurality (e.g., thousands, hundreds of thousands, etc.) of training iterations.

A user 523 can include any type of user, such as a person; an account associated with a username; an organization; or other user type.

A feedback input 524 can include, for example, any data indicative of a user evaluation of a selected output 218. A feedback input 524 can include, for example, any type of input (e.g., communication such as network communication, signal, etc.; interface interaction such as application programming interface (API) call or graphical user interface (GUI) interaction; or any other input type). Data associated with feedback input 524 can include one type or many types of data (e.g., numerical data, binary data, Boolean data, structured data, natural language data, text data, audio data, etc.). In some instances, a feedback input 524 can include numerical data indicative of an evaluation score provided by a user; binary or Boolean data associated with a user interaction (e.g., thumbs up, thumbs down, etc.); or other data indicative of a user-determined evaluation of a selected output 218.

A model update 526 can include, for example, any update to a machine-learned model 108, 212 (e.g., change to one or more parameters of the machine-learned model 108, 212, etc.). In some instances, performing a model update 526 based on feedback inputs 524 can include providing a machine-learned model 108, 212 with an input; generating, based on the input, the selected output(s) 218; receiving feedback input(s) 524 indicative of an evaluation (e.g., numerical evaluation score, loss value, etc.) of the selected output(s) 218; determining a loss value based on the evaluation; and updating one or more parameters of the machine-learned model 108, 212 based on the loss value. For training a machine-learned evaluation model 212, determining a loss value can include determining a loss value based on a difference between a numerical evaluation score associated with the feedback inputs 524 and a predicted numerical evaluation score generated by the machine-learned evaluation model 212. For training a machine-learned evaluation model 212, the feedback inputs 524 can be used directly as an objective function, or a loss value can be determined based on the feedback inputs 524 (e.g., based on a difference between the feedback inputs 524 and a maximum evaluation score, etc.). Updating one or more parameters based on the loss value can include, for example, backpropagating the loss via gradient-based methods such as gradient descent.

FIG. 6 depicts a block diagram of an example system for machine-learned insight summarization according to example aspects of the present disclosure. A structured analysis system 104 can process user time series data 602 and general time series data 628 to generate structured insight data 106. The structured insight data 106 can be provided to a machine-learned generation model 108, which can generate one or more candidate output(s) 210 based on the structured insight data 106. A machine-learned evaluation model 212 can be provided with the structured insight data 106, and can evaluate the candidate outputs 210 based at least in part on the structured insight data 106 to generate one or more evaluation(s) 214. Based on the evaluation(s) 214, a computing system 216 can select zero or more selected output(s) 218 from the candidate output(s) 210, and can output the selected output(s) 218 (e.g., to a user).

User-specific time series data 602 can be, comprise, be comprised by, or otherwise share one or more properties with time series data 102. For example, user-specific time series data 602 can have any property described above with respect to time series data 102. In some instances, user-specific time series data 602 can include time series data 102 associated with one user (e.g., person, account, organization, etc.) or multiple users (e.g., a group of related users, such as all employees of an organization, etc.).

General time series data 628 can be, comprise, be comprised by, or otherwise share one or more properties with time series data 102. For example, general time series data 628 can have any property described above with respect to time series data 102. In some instances, general time series data 628 can include time series data 102 associated with a plurality of unrelated users (e.g., all users, etc.) or related users (e.g., all users associated with a particular market segment such as e-commerce, apparel, travel, games, etc.).

In some instances, a candidate output 210 can include a comparison between user-specific time series data 602 and general time series data 628. For example, in some instances, a candidate output 210 can include a benchmarking analysis, wherein structured insight data 106 (e.g., trend data, segment analysis data, etc.) of a particular user 523 can be compared to corresponding data of a plurality of related users 523 (e.g., users associated with a same market segment as vehicles, cars, sports cars, Porsche brand sports cars, etc.; users associated with a same user type such as e-commerce business, affiliate marketer, etc.; or other grouping of related users 523). For example, a candidate output 210 summarizing a trend associated with structured insight data 106 can include a benchmarking analysis explaining whether a similar trend has occurred for similar users 523; whether the user 523 of interest's trend is stronger or weaker than a corresponding trend for similar users 523; etc. As a non-limiting illustrative example, a user 523 associated with an e-commerce gift shop (e.g., flower shop, etc.) may see an increase in conversion rate immediately before Mother's day, and a benchmarking analysis may compare a magnitude of the user 523's increase in conversion rate to an increase in conversion rate of similar users (e.g., other e-commerce gift shops, other flower shops, etc.). In some instances, the benchmarking analysis can include an analysis of normalized or relative metrics (e.g., ratios between a first data value and second data value, etc., such as ratio or rate data; percentage increase in a data value over time; etc.). For example, using normalized or relative metrics can in some instances facilitate an apples-to-apples comparison between users (e.g., accounts, businesses, etc.) of different sizes, thereby facilitating market-segment-based for a wide variety of entity sizes. In some instances, a user 523 can be associated with a plurality of market segments in a hierarchical taxonomy. As a non-limiting illustrative example, a Porsche dealer or BMW dealer may belong to a broad market segment such as automotive; a narrower market segment such as luxury cars; an even narrower market segment such as luxury sports cars; and so on. In some instances, a segment size threshold (e.g., 100, etc.) can be employed, and a benchmarking analysis can be performed for a user 523's narrowest market segment having a number of users larger than the segment size threshold.

In some instances, a structured analysis for generating structured insight data 106 can include a comparison between user-specific time series data 602 and general time series data 628. For example, in some instances, a determination of whether a user-specific trend is interesting enough to be surfaced to a machine-learned generation model 108 as structured insight data 106 may in some instances depend on a comparison between the user-specific trend and a general trend associated with all users, users similar to the user of interest, or other general plurality of users.

### Example Model Arrangements

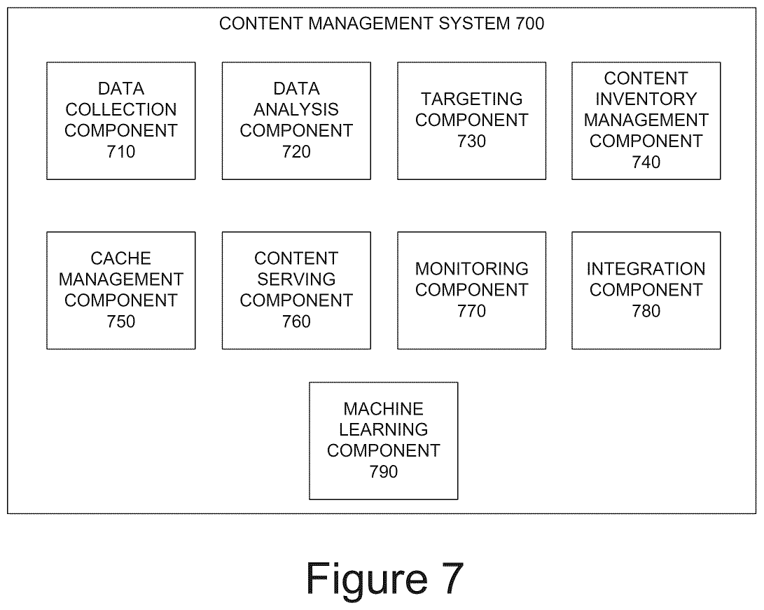

FIG. 7 depicts a block diagram of a content management system 700 according to example embodiments of the present disclosure. The content management system 700 can include a data collection component 710, a data analysis component 720, a targeting component 730, a content inventory management component 740, a cache management component 150, a content serving component 760, a monitoring component 770, an integration component 780, and a machine learning component 790.

The components 710-790 can communicate with each other and work together to collect, process, store, and serve targeted content to users efficiently. By orchestrating components 710-790 effectively, the content management system 700 can deliver content items to users in a timely and relevant manner, maximizing content publishing campaign effectiveness while minimizing operational overhead.

The data collection component 710 can receive raw data (e.g., raw time series data 102, etc.) from various sources, including websites, mobile apps, content campaign management systems, and third-party data providers. The raw data can include user interactions, browsing history, search queries, demographics, location information, and device types among other types of raw data.

In some embodiments, the raw data can include data indicative of impressions generated by content items owned by the content provider provided at the source. For example, if a visual content item was displayed on an instance of a web page owned by the source, an impression can be generated by the source indicating that the content item was presented to a user of the source. A number of impressions for different content items can be tracked by the source and provided back to the data collection component 710. Other raw data associated with the impressions, such as demographic data, click-through data, viewing data, and the like can also be sent from the source to the data collection component 710.

In some embodiments, obtaining the raw data can include providing credentials to access the source from which the raw data is obtained. For example, certain platforms may require login credentials or other security credentials before allowing the data collection component 710 to receive the raw data from the platform. The data collection component 710 can obtain the required credentials from a user or from a credential storage location and provide the required credentials to the platform for access to the raw data.

In some embodiments, obtaining the raw data can include utilizing an application programming interface (“API”) call at the source to retrieve the raw data from the source.

The data analysis component 720 can process and analyze the raw data to generate analysis data. The analysis data can include meaningful insights, hints, and relevant information the impressions garnered by the provision of content items to sources. The data analysis component 720 can involve real-time stream processing as well as batch processing of historical data. Techniques such as machine learning (e.g., machine-learned generation model 108, etc.), data mining, and statistical analysis can be employed to derive user preferences, interests, and behavior patterns.

In some embodiments, the data analysis component 720 can perform data conversion on the received raw data to a format usable by the content management system 700. For example, different platforms or sources can provide raw data to the content management system 700 in different reporting formats, data formats, and the like.

The targeting component 730 can determine which content item to serve each user based on the process data generated by the data analysis component 720. In some instances, the targeting component 730 can match user attributes (e.g., demographics, interests) with targeting criteria specified by the content provider. Additionally, the targeting component 730 can utilize machine-learned models, algorithms and rules to select the most relevant content item for each user in real-time.

The content inventory management component 740 can manage the inventory of available content items that can be served to users. The content inventory management component 740 can store information about content item creatives, targeting criteria, bidding information, and campaign budgets. Additionally, the content provider can interact with the content inventory management component 740 to upload and manage their content item campaigns.

The cache management component 750 includes a content item targeting cache. The content item targeting cache stores precomputed targeting decisions and content item creatives. The cache management component optimizes content item serving by reducing latency and improving scalability. Additionally, the content management system 700 can include cache eviction policies and strategies that are implemented to manage cache size and ensure freshness of data.

The content serving component 760 can serve content items to users in real-time. In some instances, the content serving component 760 can serve a content item stored in the cache management component 750 based on the targeting decisions. The content serving component 760 can interface with websites, mobile apps, or other digital platforms where the content items are displayed.

The monitoring component 770 can provide monitoring, logging, and reporting capabilities to track system performance, content delivery metrics, and compliance with regulations. The monitoring component 770 can generate alerts and notifications for issues such as downtime, performance degradation, or policy violations.

The integration component 780 can facilitate integration with external systems such as demand-side platforms, data management platforms, content item exchanges, and content item networks. APIs and standard protocols can be used for seamless communication between different components of the content tech ecosystem.

### Example Methods

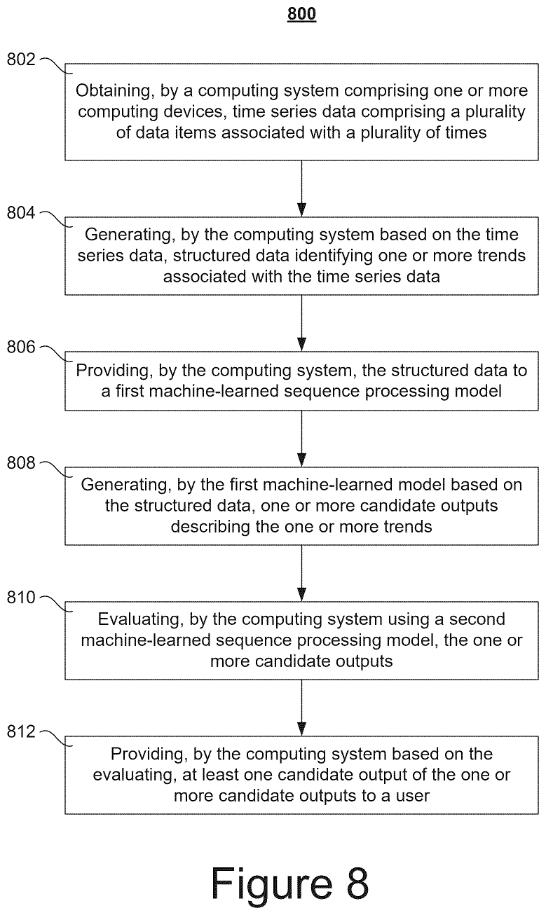

FIG. 8 depicts a flow chart diagram of an example method to perform according to example embodiments of the present disclosure. Although FIG. 8 depicts steps performed in a particular order for purposes of illustration and discussion, the methods of the present disclosure are not limited to the particularly illustrated order or arrangement. The various steps of the method 800 can be omitted, rearranged, combined, and/or adapted in various ways without deviating from the scope of the present disclosure.

At 802, example method 800 can include obtaining, by a computing system (e.g., computing system 216, etc.) comprising one or more computing devices, time series data (e.g., time series data 102) comprising a plurality of data items associated with a plurality of times. In some instances, example method 800 at 802 can include using one or more systems or performing one or more activities described with respect to FIGS. 1-7.

At 804, example method 800 can include generating, by the computing system based on the time series data, structured data (e.g., structured insight data 106) identifying one or more trends associated with the time series data. In some instances, example method 800 at 804 can include using one or more systems or performing one or more activities described with respect to FIGS. 1-7.

At 806, example method 800 can include providing, by the computing system, the structured data to a first machine-learned sequence processing model (e.g., machine-learned generation model 108, etc.). In some instances, example method 800 at 806 can include using one or more systems or performing one or more activities described with respect to FIGS. 1-5.

At 808, example method 800 can include generating, by the first machine-learned model based on the structured data, one or more candidate outputs (e.g., candidate outputs 210) describing the one or more trends. In some instances, example method 800 at 808 can include using one or more systems or performing one or more activities described with respect to FIGS. 1-7.

At 810, example method 800 can include evaluating, by the computing system using a second machine-learned sequence processing model (e.g., machine-learned evaluation model 212), the one or more candidate outputs. In some instances, example method 800 at 810 can include using one or more systems or performing one or more activities described with respect to FIGS. 1-7.

At 812, example method 800 can include providing, by the computing system based on the evaluating, at least one candidate output of the one or more candidate outputs to a user (e.g., user 523). In some instances, example method 800 at 812 can include using one or more systems or performing one or more activities described with respect to FIGS. 1-7.

### Example Devices and Systems

FIG. 9A depicts a block diagram of an example computing system 900 that performs insight summary generation according to example embodiments of the present disclosure. The system 900 includes a user computing device 902, a server computing system 930, and a training computing system 950 that are communicatively coupled over a network 980.

The user computing device 902 can be any type of computing device, such as, for example, a personal computing device (e.g., laptop or desktop), a mobile computing device (e.g., smartphone or tablet), a gaming console or controller, a wearable computing device, an embedded computing device, or any other type of computing device.

The user computing device 902 includes one or more processors 912 and a memory 914. The one or more processors 912 can be any suitable processing device (e.g., a processor core, a microprocessor, an ASIC, an FPGA, a controller, a microcontroller, etc.) and can be one processor or a plurality of processors that are operatively connected. The memory 914 can include one or more non-transitory computer-readable storage media, such as RAM, ROM, EEPROM, EPROM, flash memory devices, magnetic disks, etc., and combinations thereof. The memory 914 can store data 916 and instructions 918 which are executed by the processor 912 to cause the user computing device 902 to perform operations.

In some implementations, the user computing device 902 can store or include one or more machine-learned models 920, such as machine-learned generation models 108 or machine-learned evaluation models 212. For example, the machine-learned models 920 can be or can otherwise include various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks. Some example machine-learned models can leverage an attention mechanism such as self-attention. For example, some example machine-learned models can include multi-headed self-attention models (e.g., transformer models). Example machine-learned models 920 are discussed with reference to FIGS. 1-5.

In some implementations, the one or more machine-learned models 920 can be received from the server computing system 930 over network 980, stored in the user computing device memory 914, and then used or otherwise implemented by the one or more processors 912. In some implementations, the user computing device 902 can implement multiple parallel instances of a single machine-learned model 920 (e.g., to perform parallel insight summary generation or evaluation across multiple instances of machine-learned generation model 108 or machine-learned evaluation model 212).

Additionally or alternatively, one or more machine-learned models 940 (e.g., machine-learned generation models 108, machine-learned evaluation models 212, etc.) can be included in or otherwise stored and implemented by the server computing system 930 that communicates with the user computing device 902 according to a client-server relationship. For example, the machine-learned models 940 can be implemented by the server computing system 930 as a portion of a web service (e.g., a content analytics service, etc.). Thus, one or more models 920 can be stored and implemented at the user computing device 902 and/or one or more models 940 can be stored and implemented at the server computing system 930.

The user computing device 902 can also include one or more user input components 922 that receives user input. For example, the user input component 922 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

The server computing system 930 includes one or more processors 932 and a memory 934. The one or more processors 932 can be any suitable processing device (e.g., a processor core, a microprocessor, an ASIC, an FPGA, a controller, a microcontroller, etc.) and can be one processor or a plurality of processors that are operatively connected. The memory 934 can include one or more non-transitory computer-readable storage media, such as RAM, ROM, EEPROM, EPROM, flash memory devices, magnetic disks, etc., and combinations thereof. The memory 934 can store data 936 and instructions 938 which are executed by the processor 932 to cause the server computing system 930 to perform operations.

In some implementations, the server computing system 930 includes or is otherwise implemented by one or more server computing devices. In instances in which the server computing system 930 includes plural server computing devices, such server computing devices can operate according to sequential computing architectures, parallel computing architectures, or some combination thereof.

As described above, the server computing system 930 can store or otherwise include one or more machine-learned models 940 (e.g., machine-learned generation models 108, machine-learned evaluation models 212, etc.). For example, the models 940 can be or can otherwise include various machine-learned models. Example machine-learned models include neural networks or other multi-layer non-linear models. Example neural networks include feed forward neural networks, deep neural networks, recurrent neural networks, and convolutional neural networks. Some example machine-learned models can leverage an attention mechanism such as self-attention. For example, some example machine-learned models can include multi-headed self-attention models (e.g., transformer models). Example models 940 are discussed with reference to FIGS. 1-5.

The user computing device 902 and/or the server computing system 930 can train the models 920 and/or 940 via interaction with the training computing system 950 that is communicatively coupled over the network 980. The training computing system 950 can be separate from the server computing system 930 or can be a portion of the server computing system 930.

The training computing system 950 includes one or more processors 952 and a memory 954. The one or more processors 952 can be any suitable processing device (e.g., a processor core, a microprocessor, an ASIC, an FPGA, a controller, a microcontroller, etc.) and can be one processor or a plurality of processors that are operatively connected. The memory 954 can include one or more non-transitory computer-readable storage media, such as RAM, ROM, EEPROM, EPROM, flash memory devices, magnetic disks, etc., and combinations thereof. The memory 954 can store data 956 and instructions 958 which are executed by the processor 952 to cause the training computing system 950 to perform operations. In some implementations, the training computing system 950 includes or is otherwise implemented by one or more server computing devices.

The training computing system 950 can include a model trainer 960 that trains the machine-learned models 920 and/or 940 stored at the user computing device 902 and/or the server computing system 930 using various training or learning techniques, such as, for example, backwards propagation of errors. For example, a loss function can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over a number of training iterations. The training can implement supervised learning, unsupervised learning, reinforcement learning, etc.

In some implementations, performing backwards propagation of errors can include performing truncated backpropagation through time. The model trainer 960 can perform a number of generalization techniques (e.g., weight decays, dropouts, etc.) to improve the generalization capability of the models being trained.

In some implementations, the model(s) 920 can be pre-trained before domain-specific alignment. For instance, a model 920 can be pretrained over a general corpus of training data and fine-tuned on a more targeted corpus of training data. A model 920 can be aligned using prompts that are designed to elicit domain-specific outputs. Prompts can be designed to include learned prompt values (e.g., soft prompts). The trained model(s) 920 may be validated prior to their use using input data other than the training data, and may be further updated or refined during their use based on additional feedback/inputs.

In particular, the model trainer 960 can train the machine-learned models 920 and/or 940 based on a set of training data 962. Training data 962 for the machine-learned generation model can include, for example, input-output pairs comprising structured insight data 106 as inputs, and example outputs 210, 218 as outputs. Training data 962 for the machine-learned evaluation model 212 can include, for example, input-output pairs comprising candidate outputs 210 as inputs, and evaluations 214 (e.g., numerical evaluation scores, etc.) as outputs. In some instances, training data 962 for the machine-learned evaluation model can also include structured insight data 106 as part of the inputs of each input-output pair. In some instances, training data 962 for the machine-learned generation model 108 or machine-learned evaluation model 212 can include, for example, input-output pairs comprising structured insight data 106 as inputs, and feedback inputs 524 as outputs.

In some implementations, if the user has provided consent, the training examples can be provided by the user computing device 902. Thus, in such implementations, the model 920 provided to the user computing device 902 can be trained by the training computing system 950 on user-specific data received from the user computing device 902. In some instances, this process can be referred to as personalizing the model.

The model trainer 960 includes computer logic utilized to provide desired functionality. The model trainer 960 can be implemented in hardware, firmware, and/or software controlling a general purpose processor. For example, in some implementations, the model trainer 960 includes program files stored on a storage device, loaded into a memory and executed by one or more processors. In other implementations, the model trainer 960 includes one or more sets of computer-executable instructions that are stored in a tangible computer-readable storage medium such as RAM, hard disk, or optical or magnetic media.

The network 980 can be any type of communications network, such as a local area network (e.g., intranet), wide area network (e.g., Internet), or some combination thereof and can include any number of wired or wireless links. In general, communication over the network 980 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

FIG. 9A illustrates one example computing system that can be used to implement the present disclosure. Other computing systems can be used as well. For example, in some implementations, the user computing device 902 can include the model trainer 960 and the training dataset 962. In such implementations, the models 920 can be both trained and used locally at the user computing device 902. In some of such implementations, the user computing device 902 can implement the model trainer 960 to personalize the models 920 based on user-specific data.

FIG. 9B depicts a block diagram of an example computing device 10 that performs according to example embodiments of the present disclosure. The computing device 10 can be a user computing device or a server computing device.

The computing device 10 includes a number of applications (e.g., applications 1 through N). Each application contains its own machine learning library and machine-learned model(s). For example, each application can include a machine-learned model. Example applications include a text messaging application, an email application, a dictation application, a virtual keyboard application, a browser application, etc.

As illustrated in FIG. 9B, each application can communicate with a number of other components of the computing device, such as, for example, one or more sensors, a context manager, a device state component, and/or additional components. In some implementations, each application can communicate with each device component using an API (e.g., a public API). In some implementations, the API used by each application is specific to that application.

FIG. 9C depicts a block diagram of an example computing device 50 that performs according to example embodiments of the present disclosure. The computing device 50 can be a user computing device or a server computing device.

The computing device 50 includes a number of applications (e.g., applications 1 through N). Each application is in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer includes a number of machine-learned models. For example, as illustrated in FIG. 9C, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of the computing device 50.

The central intelligence layer can communicate with a central device data layer. The central device data layer can be a centralized repository of data for the computing device 50. As illustrated in FIG. 9C, the central device data layer can communicate with a number of other components of the computing device, such as, for example, one or more sensors, a context manager, a device state component, and/or additional components. In some implementations, the central device data layer can communicate with each device component using an API (e.g., a private API).

### Example Training Method

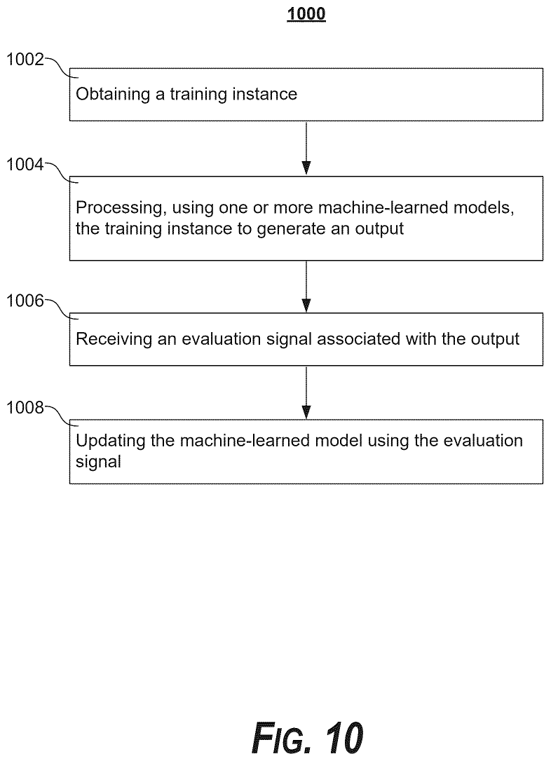

FIG. 10 depicts a flowchart of a method 1000 for training one or more machine-learned models according to aspects of the present disclosure. For instance, an example machine-learned model can include a machine-learned generation model 108 or machine-learned evaluation model 212)

One or more portion(s) of example method 1000 can be implemented by a computing system that includes one or more computing devices such as, for example, computing systems described with reference to the other figures. Each respective portion of example method 1000 can be performed by any (or any combination) of one or more computing devices. Moreover, one or more portion(s) of example method 1000 can be implemented on the hardware components of the device(s) described herein, for example, to train one or more systems or models. FIG. 10 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 10 is described with reference to elements/terms described with respect to other systems and figures for exemplary illustrated purposes and is not meant to be limiting. One or more portions of example method 1000 can be performed additionally, or alternatively, by other systems.

At 1002, example method 1000 can include obtaining a training instance. A set of training data can include a plurality of training instances divided between multiple datasets (e.g., a training dataset, a validation dataset, or testing dataset). A training instance can be labeled or unlabeled. Although referred to in example method 1000 as a “training” instance, it is to be understood that runtime inferences can form training instances when a model is trained using an evaluation of the model's performance on that runtime instance (e.g., online training/learning). Example data types for the training instance and various tasks associated therewith are described throughout the present disclosure.

At 1004, example method 1000 can include processing, using one or more machine-learned models, the training instance to generate an output. The output can be directly obtained from the one or more machine-learned models or can be a downstream result of a chain of processing operations that includes an output of the one or more machine-learned models.

At 1006, example method 1000 can include receiving an evaluation signal associated with the output. The evaluation signal can be obtained using a loss function. Various determinations of loss can be used, such as mean squared error, likelihood loss, cross entropy loss, hinge loss, contrastive loss, or various other loss functions. The evaluation signal can be computed using known ground-truth labels (e.g., supervised learning), predicted or estimated labels (e.g., semi-or self-supervised learning), or without labels (e.g., unsupervised learning). The evaluation signal can be a reward (e.g., for reinforcement learning). The reward can be computed using a machine-learned reward model configured to generate rewards based on output(s) received. The reward can be computed using feedback data describing human feedback on the output(s).

At 1008, example method 1000 can include updating the machine-learned model using the evaluation signal. For example, values for parameters of the machine-learned model(s) can be learned, in some embodiments, using various training or learning techniques, such as, for example, backwards propagation. For example, the evaluation signal can be backpropagated from the output (or another source of the evaluation signal) through the machine-learned model(s) to update one or more parameters of the model(s) (e.g., based on a gradient of the evaluation signal with respect to the parameter value(s)). For example, system(s) containing one or more machine-learned models can be trained in an end-to-end manner. Gradient descent techniques can be used to iteratively update the parameters over a number of training iterations. In some implementations, performing backwards propagation of errors can include performing truncated backpropagation through time. Example method 1000 can include implementing a number of generalization techniques (e.g., weight decays, dropouts, etc.) to improve the generalization capability of the models being trained.

In some implementations, example method 1000 can be implemented for training a machine-learned model from an initialized state to a fully trained state (e.g., when the model exhibits a desired performance profile, such as based on accuracy, precision, recall, etc.).

In some implementations, example method 1000 can be implemented for particular stages of a training procedure. For instance, in some implementations, example method 1000 can be implemented for pre-training a machine-learned model. Pre-training can include, for instance, large-scale training over potentially noisy data to achieve a broad base of performance levels across a variety of tasks/data types. In some implementations, example method 1000 can be implemented for fine-tuning a machine-learned model. Fine-tuning can include, for instance, smaller-scale training on higher-quality (e.g., labeled, curated, etc.) data. Fine-tuning can affect all or a portion of the parameters of a machine-learned model. For example, various portions of the machine-learned model can be “frozen” for certain training stages. For example, parameters associated with an embedding space can be “frozen” during fine-tuning (e.g., to retain information learned from a broader domain(s) than present in the fine-tuning dataset(s)). An example fine-tuning approach includes reinforcement learning. Reinforcement learning can be based on user feedback on model performance during use.

### Example Machine-Learned Models

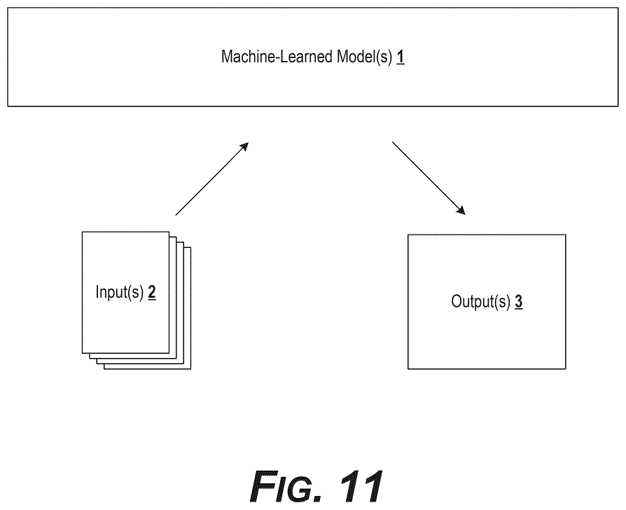

FIG. 11 is a block diagram of an example processing flow for using machine-learned model(s) 1 to process input(s) 2 to generate output(s) 3.

Machine-learned model(s) 1 can be or include one or multiple machine-learned models or model components. Example machine-learned models can include neural networks (e.g., deep neural networks). Example machine-learned models can include non-linear models or linear models. Example machine-learned models can use other architectures in lieu of or in addition to neural networks. Example machine-learned models can include decision tree based models, support vector machines, hidden Markov models, Bayesian networks, linear regression models, k-means clustering models, etc.

Example neural networks can include feed-forward neural networks, recurrent neural networks (RNNs), including long short-term memory (LSTM) based recurrent neural networks, convolutional neural networks (CNNs), diffusion models, generative-adversarial networks, or other forms of neural networks. Example neural networks can be deep neural networks. Some example machine-learned models can leverage an attention mechanism such as self-attention. For example, some example machine-learned models can include multi-headed self-attention models.

Machine-learned model(s) 1 can include a single or multiple instances of the same model configured to operate on data from input(s) 2. Machine-learned model(s) 1 can include an ensemble of different models that can cooperatively interact to process data from input(s) 2. For example, machine-learned model(s) 1 can employ a mixture-of-experts structure. See, e.g., Zhou et al., Mixture-of-Experts with Expert Choice Routing, ARXIV: 2202.09368v2 (Oct. 14, 2022).

Input(s) 2 can generally include or otherwise represent various types of data. Input(s) 2 can include one type or many different types of data. Output(s) 3 can be data of the same type(s) or of different types of data as compared to input(s) 2. Output(s) 3 can include one type or many different types of data.

Example data types for input(s) 2 or output(s) 3 include natural language text data, software code data (e.g., source code, object code, machine code, or any other form of computer-readable instructions or programming languages), machine code data (e.g., binary code, assembly code, or other forms of machine-readable instructions that can be executed directly by a computer's central processing unit), assembly code data (e.g., low-level programming languages that use symbolic representations of machine code instructions to program a processing unit), genetic data or other chemical or biochemical data, image data, audio data, audiovisual data, haptic data, biometric data, medical data, financial data, statistical data, geographical data, astronomical data, historical data, sensor data generally (e.g., digital or analog values, such as voltage or other absolute or relative level measurement values from a real or artificial input, such as from an audio sensor, light sensor, displacement sensor, etc.), and the like. Data can be raw or processed and can be in any format or schema.

In multimodal inputs 2 or outputs 3, example combinations of data types include image data and audio data, image data and natural language data, natural language data and software code data, image data and biometric data, sensor data and medical data, etc. It is to be understood that any combination of data types in an input 2 or an output 3 can be present.

An example input 2 can include one or multiple data types, such as the example data types noted above. An example output 3 can include one or multiple data types, such as the example data types noted above. The data type(s) of input 2 can be the same as or different from the data type(s) of output 3. It is to be understood that the example data types noted above are provided for illustrative purposes only. Data types contemplated within the scope of the present disclosure are not limited to those examples noted above.

### Example Machine-Learned Sequence Processing Models

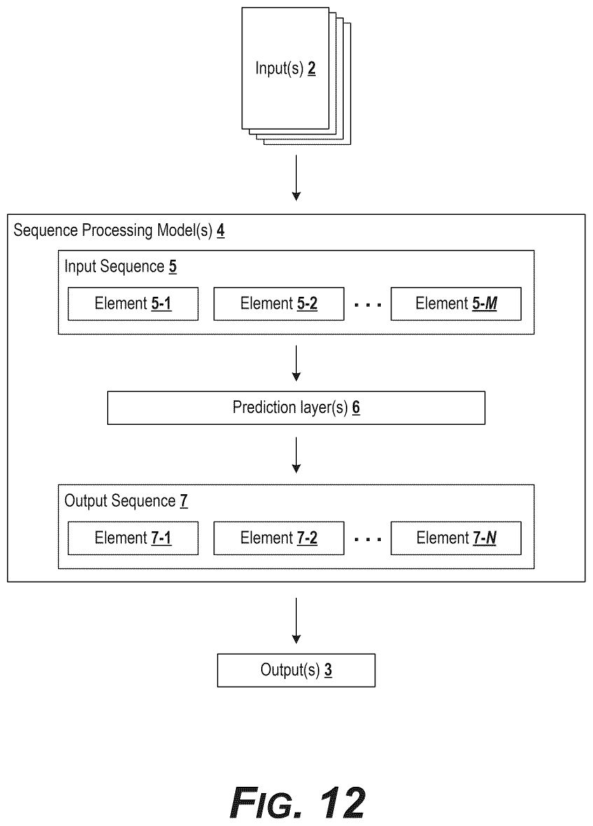

FIG. 12 is a block diagram of an example implementation of an example machine-learned model configured to process sequences of information. For instance, an example implementation of machine-learned model(s) 1 can include machine-learned sequence processing model(s) 4. An example system can pass input(s) 2 to sequence processing model(s) 4. Sequence processing model(s) 4 can include one or more machine-learned components. Sequence processing model(s) 4 can process the data from input(s) 2 to obtain an input sequence 5. Input sequence 5 can include one or more input elements 5-1, 5-2, . . . , 5-M, etc. obtained from input(s) 2. Sequence processing model 4 can process input sequence 5 using prediction layer(s) 6 to generate an output sequence 7. Output sequence 7 can include one or more output elements 7-1, 7-2, . . . , 7-N, etc. generated based on input sequence 5. The system can generate output(s) 3 based on output sequence 7.

Sequence processing model(s) 4 can include one or multiple machine-learned model components configured to ingest, generate, or otherwise reason over sequences of information. For example, some example sequence processing models in the text domain are referred to as “Large Language Models,” or LLMs. See, e.g., PaLM 2 Technical Report, GOOGLE, https://ai.google/static/documents/palm2techreport.pdf (n.d.). Other example sequence processing models can operate in other domains, such as image domains, see, e.g., Dosovitskiy et al., An Image is Worth 16×16 Words: Transformers for Image Recognition at Scale, ARXIV: 2010.11929v2 (Jun. 3, 2021), audio domains, see, e.g., Agostinelli et al., MusicLM: Generating Music From Text, ARXIV: 2301.11325v1 (Jan. 26, 2023), biochemical domains, see, e.g., Jumper et al., Highly accurate protein structure prediction with AlphaFold, 596 Nature 583 (Aug. 26, 2021), by way of example. Sequence processing model(s) 4 can process one or multiple types of data simultaneously. Sequence processing model(s) 4 can include relatively large models (e.g., more parameters, computationally expensive, etc.), relatively small models (e.g., fewer parameters, computationally lightweight, etc.), or both.

In general, sequence processing model(s) 4 can obtain input sequence 5 using data from input(s) 2. For instance, input sequence 5 can include a representation of data from input(s) 2 in a format understood by sequence processing model(s) 4. One or more machine-learned components of sequence processing model(s) 4 can ingest the data from input(s) 2, parse the data into pieces compatible with the processing architectures of sequence processing model(s) 4 (e.g., via “tokenization”), and project the pieces into an input space associated with prediction layer(s) 6 (e.g., via “embedding”).

Sequence processing model(s) 4 can ingest the data from input(s) 2 and parse the data into a sequence of elements to obtain input sequence 5. For example, a portion of input data from input(s) 2 can be broken down into pieces that collectively represent the content of the portion of the input data. The pieces can provide the elements of the sequence.

Elements 5-1, 5-2, . . . , 5-M can represent, in some cases, building blocks for capturing or expressing meaningful information in a particular data domain. For instance, the elements can describe “atomic units” across one or more domains. For example, for textual input source(s), the elements can correspond to groups of one or more words or sub-word components, such as sets of one or more characters.

For example, elements 5-1, 5-2, . . . , 5-M can represent tokens obtained using a tokenizer. For instance, a tokenizer can process a given portion of an input source and output a series of tokens (e.g., corresponding to input elements 5-1, 5-2, . . . , 5-M) that represent the portion of the input source. Various approaches to tokenization can be used. For instance, textual input source(s) can be tokenized using a byte-pair encoding (BPE) technique. See, e.g., Kudo et al., SentencePiece: A simple and language independent subword tokenizer and detokenizer for Neural Text Processing, PROCEEDINGS OF THE 2018 CONFERENCE ON EMPIRICAL METHODS IN NATURAL LANGUAGE PROCESSING (System Demonstrations), pages 66-71 (Oct. 31-Nov. 4, 2018), https://aclanthology.org/D18-2012.pdf. Image-based input source(s) can be tokenized by extracting and serializing patches from an image.

In general, arbitrary data types can be serialized and processed into input sequence 5. It is to be understood that element(s) 5-1, 5-2, . . . , 5-M depicted in FIG. 12 can be the tokens or can be the embedded representations thereof.

Prediction layer(s) 6 can predict one or more output elements 7-1, 7-2, . . . , 7-N based on the input elements. Prediction layer(s) 6 can include one or more machine-learned model architectures, such as one or more layers of learned parameters that manipulate and transform the input(s) to extract higher-order meaning from, and relationships between, input element(s) 5-1, 5-2, . . . , 5-M. In this manner, for instance, example prediction layer(s) 6 can predict new output element(s) in view of the context provided by input sequence 5.

Prediction layer(s) 6 can evaluate associations between portions of input sequence 5 and a particular output element. These associations can inform a prediction of the likelihood that a particular output follows the input context. For example, consider the textual snippet, “The carpenter's toolbox was small and heavy. It was full of ______.” Example prediction layer(s) 6 can identify that “It” refers back to “toolbox” by determining a relationship between the respective embeddings. Example prediction layer(s) 6 can also link “It” to the attributes of the toolbox, such as “small” and “heavy.” Based on these associations, prediction layer(s) 6 can, for instance, assign a higher probability to the word “nails” than to the word “sawdust.”

A transformer is an example architecture that can be used in prediction layer(s) 4. See, e.g., Vaswani et al., Attention Is All You Need, ARXIV: 1706.03762v7 (Aug. 2, 2023). A transformer is an example of a machine-learned model architecture that uses an attention mechanism to compute associations between items within a context window. The context window can include a sequence that contains input sequence 5 and potentially one or more output element(s) 7-1, 7-2, . . . , 7-N. A transformer block can include one or more attention layer(s) and one or more post-attention layer(s) (e.g., feedforward layer(s), such as a multi-layer perceptron).

Prediction layer(s) 6 can include other machine-learned model architectures in addition to or in lieu of transformer-based architectures. For example, recurrent neural networks (RNNs) and long short-term memory (LSTM) models can also be used, as well as convolutional neural networks (CNNs). In general, prediction layer(s) 6 can leverage various kinds of artificial neural networks that can understand or generate sequences of information.

Output sequence 7 can include or otherwise represent the same or different data types as input sequence 5. For instance, input sequence 5 can represent textual data, and output sequence 7 can represent textual data. Input sequence 5 can represent image, audio, or audiovisual data, and output sequence 7 can represent textual data (e.g., describing the image, audio, or audiovisual data). It is to be understood that prediction layer(s) 6, and any other interstitial model components of sequence processing model(s) 4, can be configured to receive a variety of data types in input sequence(s) 5 and output a variety of data types in output sequence(s) 7.

Output sequence 7 can have various relationships to input sequence 5. Output sequence 7 can be a continuation of input sequence 5. Output sequence 7 can be complementary to input sequence 5. Output sequence 7 can translate, transform, augment, or otherwise modify input sequence 5. Output sequence 7 can answer, evaluate, confirm, or otherwise respond to input sequence 5. Output sequence 7 can implement (or describe instructions for implementing) an instruction provided via input sequence 5.

Output sequence 7 can be generated autoregressively. For instance, for some applications, an output of one or more prediction layer(s) 6 can be passed through one or more output layers (e.g., softmax layer) to obtain a probability distribution over an output vocabulary (e.g., a textual or symbolic vocabulary) conditioned on a set of input elements in a context window. In this manner, for instance, output sequence 7 can be autoregressively generated by sampling a likely next output element, adding that element to the context window, and re-generating the probability distribution based on the updated context window, and sampling a likely next output element, and so forth.

Output sequence 7 can also be generated non-autoregressively. For instance, multiple output elements of output sequence 7 can be predicted together without explicit sequential conditioning on each other. See, e.g., Saharia et al., Non-Autoregressive Machine Translation with Latent Alignments, ARXIV: 2004.07437v3 (Nov. 16, 2020).

Output sequence 7 can include one or multiple portions or elements. In an example content generation configuration, output sequence 7 can include multiple elements corresponding to multiple portions of a generated output sequence (e.g., a textual sentence, values of a discretized waveform, computer code, etc.). In an example classification configuration, output sequence 7 can include a single element associated with a classification output. For instance, an output “vocabulary” can include a set of classes into which an input sequence is to be classified. For instance, a vision transformer block can pass latent state information to a multilayer perceptron that outputs a likely class value associated with an input image.

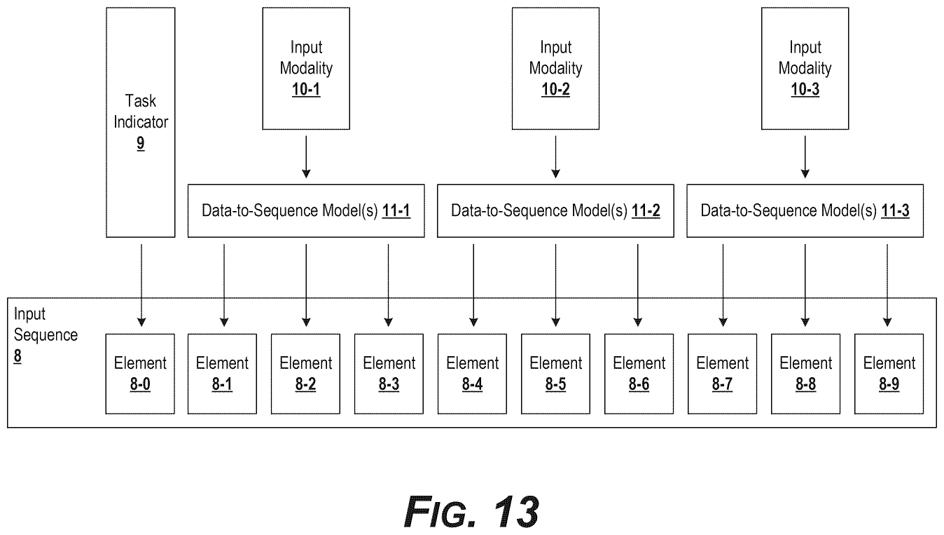

FIG. 13 is a block diagram of an example technique for populating an example input sequence 8. Input sequence 8 can include various functional elements that form part of the model infrastructure, such as an element 8-0 obtained from a task indicator 9 that signals to any model(s) that process input sequence 8 that a particular task is being performed (e.g., to help adapt a performance of the model(s) to that particular task). Input sequence 8 can include various data elements from different data modalities. For instance, an input modality 10-1 can include one modality of data. A data-to-sequence model 11-1 can process data from input modality 10-1 to project the data into a format compatible with input sequence 8 (e.g., one or more vectors dimensioned according to the dimensions of input sequence 8) to obtain elements 8-1, 8-2, 8-3. Another input modality 10-2 can include a different modality of data. A data-to-sequence model 11-2 can project data from input modality 10-2 into a format compatible with input sequence 8 to obtain elements 8-4, 8-5, 8-6. Another input modality 10-3 can include yet another different modality of data. A data-to-sequence model 11-3 can project data from input modality 10-3 into a format compatible with input sequence 8 to obtain elements 8-7, 8-8, 8-9.

Input sequence 8 can be the same as or different from input sequence 5. Input sequence 8 can be a multimodal input sequence that contains elements that represent data from different modalities using a common dimensional representation. For instance, an embedding space can have P dimensions. Input sequence 8 can be configured to contain a plurality of elements that have P dimensions. In this manner, for instance, example implementations can facilitate information extraction and reasoning across diverse data modalities by projecting data into elements in the same embedding space for comparison, combination, or other computations therebetween.

For example, elements 8-0, . . . , 8-9 can indicate particular locations within a multidimensional embedding space. Some elements can map to a set of discrete locations in the embedding space. For instance, elements that correspond to discrete members of a predetermined vocabulary of tokens can map to discrete locations in the embedding space that are associated with those tokens. Other elements can be continuously distributed across the embedding space. For instance, some data types can be broken down into continuously defined portions (e.g., image patches) that can be described using continuously distributed locations within the embedding space.

In some implementations, the expressive power of the embedding space may not be limited to meanings associated with any particular set of tokens or other building blocks. For example, a continuous embedding space can encode a spectrum of high-order information. An individual piece of information (e.g., a token) can map to a particular point in that space: for instance, a token for the word “dog” can be projected to an embedded value that points to a particular location in the embedding space associated with canine-related information. Similarly, an image patch of an image of a dog on grass can also be projected into the embedding space. In some implementations, the projection of the image of the dog can be similar to the projection of the word “dog” while also having similarity to a projection of the word “grass,” while potentially being different from both. In some implementations, the projection of the image patch may not exactly align with any single projection of a single word. In some implementations, the projection of the image patch can align with a combination of the projections of the words “dog” and “grass.” In this manner, for instance, a high-order embedding space can encode information that can be independent of data modalities in which the information is expressed.

Task indicator 9 can include a model or model component configured to identify a task being performed and inject, into input sequence 8, an input value represented by element 8-0 that signals which task is being performed. For instance, the input value can be provided as a data type associated with an input modality and projected along with that input modality (e.g., the input value can be a textual task label that is embedded along with other textual data in the input; the input value can be a pixel-based representation of a task that is embedded along with other image data in the input; etc.). The input value can be provided as a data type that differs from or is at least independent from other input(s). For instance, the input value represented by element 8-0 can be a learned within a continuous embedding space.

Input modalities 10-1, 10-2, and 10-3 can be associated with various different data types (e.g., as described above with respect to input(s) 2 and output(s) 3).

Data-to-sequence models 11-1, 11-2, and 11-3 can be the same or different from each other. Data-to-sequence models 11-1, 11-2, and 11-3 can be adapted to each respective input modality 10-1, 10-2, and 10-3. For example, a textual data-to-sequence model can subdivide a portion of input text and project the subdivisions into element(s) in input sequence 8 (e.g., elements 8-1, 8-2, 8-3, etc.). An image data-to-sequence model can subdivide an input image and project the subdivisions into element(s) in input sequence 8 (e.g., elements 8-4, 8-5, 8-6, etc.). An arbitrary datatype data-to-sequence model can subdivide an input of that arbitrary datatype and project the subdivisions into element(s) in input sequence 8 (e.g., elements 8-7, 8-8, 8-9, etc.).

Data-to-sequence models 11-1, 11-2, and 11-3 can form part of machine-learned sequence processing model(s) 4. Data-to-sequence models 11-1, 11-2, and 11-3 can be jointly trained with or trained independently from machine-learned sequence processing model(s) 4. Data-to-sequence models 11-1, 11-2, and 11-3 can be trained end-to-end with machine-learned sequence processing model(s) 4.

### Example Machine-Learned Model Development Platform

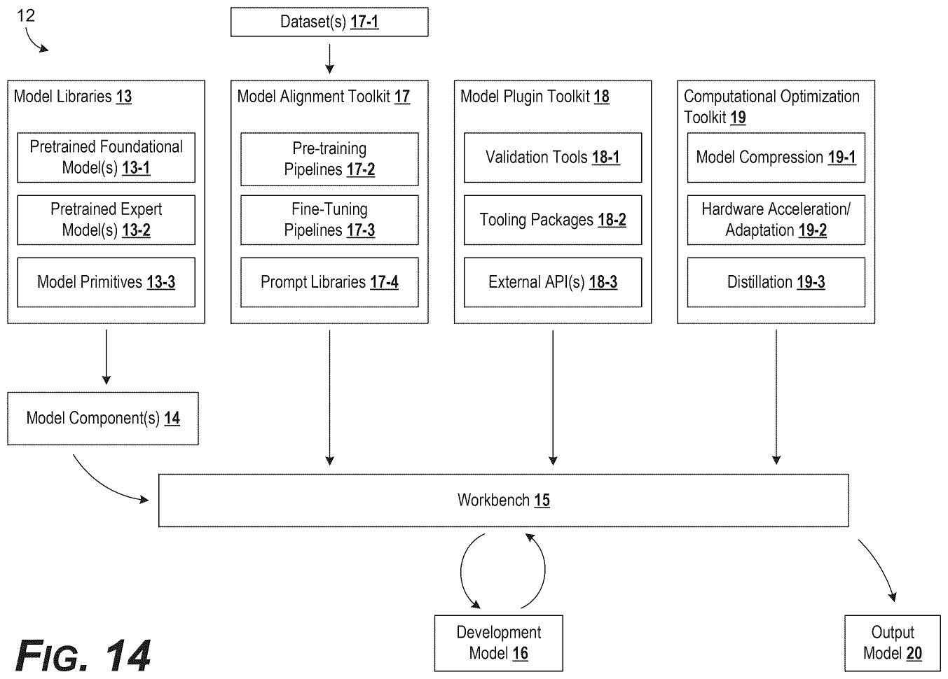

FIG. 14 is a block diagram of an example model development platform 12 that can facilitate creation, adaptation, and refinement of example machine-learned models (e.g., machine-learned model(s) 1, sequence processing model(s) 4, etc.). Model development platform 12 can provide a number of different toolkits that developer systems can employ in the development of new or adapted machine-learned models.

Model development platform 12 can provide one or more model libraries 13 containing building blocks for new models. Model libraries 13 can include one or more pre-trained foundational models 13-1, which can provide a backbone of processing power across various tasks. Model libraries 13 can include one or more pre-trained expert models 13-2, which can be focused on performance in particular domains of expertise. Model libraries 13 can include various model primitives 13-3, which can provide low-level architectures or components (optionally pre-trained), which can be assembled in various arrangements as desired.

Model development platform 12 can receive selections of various model components 14. Model development platform 12 can pass selected model components 14 to a workbench 15 that combines selected model components 14 into a development model 16.

Workbench 15 can facilitate further refinement and adaptation of development model 16 by leveraging a number of different toolkits integrated with model development platform 12. For example, workbench 15 can facilitate alignment of the development model 16 with a desired performance profile on various tasks using a model alignment toolkit 17.

Model alignment toolkit 17 can provide a number of tools for causing development model 16 to generate outputs aligned with desired behavioral characteristics. Alignment can include increasing an accuracy, precision, recall, etc. of model outputs. Alignment can include enforcing output styles, schema, or other preferential characteristics of model outputs. Alignment can be general or domain-specific. For instance, a pre-trained foundational model 13-1 can begin with an initial level of performance across multiple domains. Alignment of the pre-trained foundational model 13-1 can include improving a performance in a particular domain of information or tasks (e.g., even at the expense of performance in another domain of information or tasks).

Model alignment toolkit 17 can integrate one or more dataset(s) 17-1 for aligning development model 16. Curated dataset(s) 17-1 can include labeled or unlabeled training data. Dataset(s) 17-1 can be obtained from public domain datasets. Dataset(s) 17-1 can be obtained from private datasets associated with one or more developer system(s) for the alignment of bespoke machine-learned model(s) customized for private use-cases.

Pre-training pipelines 17-2 can include a machine-learned model training workflow configured to update development model 16 over large-scale, potentially noisy datasets. For example, pre-training can leverage unsupervised learning techniques (e.g., de-noising, etc.) to process large numbers of training instances to update model parameters from an initialized state and achieve a desired baseline performance. Pre-training pipelines 17-2 can leverage unlabeled datasets in dataset(s) 17-1 to perform pre-training. Workbench 15 can implement a pre-training pipeline 17-2 to pre-train development model 16.

Fine-tuning pipelines 17-3 can include a machine-learned model training workflow configured to refine the model parameters of development model 16 with higher-quality data. Fine-tuning pipelines 17-3 can update development model 16 by conducting supervised training with labeled dataset(s) in dataset(s) 17-1. Fine-tuning pipelines 17-3 can update development model 16 by conducting reinforcement learning using reward signals from user feedback signals. Workbench 15 can implement a fine-tuning pipeline 17-3 to fine-tune development model 16.

Prompt libraries 17-4 can include sets of inputs configured to induce behavior aligned with desired performance criteria. Prompt libraries 17-4 can include few-shot prompts (e.g., inputs providing examples of desired model outputs for prepending to a desired runtime query), chain-of-thought prompts (e.g., inputs providing step-by-step reasoning within the exemplars to facilitate thorough reasoning by the model), and the like.

Example prompts can be retrieved from an available repository of prompt libraries 17-4. Example prompts can be contributed by one or more developer systems using workbench 15.

In some implementations, pre-trained or fine-tuned models can achieve satisfactory performance without exemplars in the inputs. For instance, zero-shot prompts can include inputs that lack exemplars. Zero-shot prompts can be within a domain within a training dataset or outside of the training domain(s).

Prompt libraries 17-4 can include one or more prompt engineering tools. Prompt engineering tools can provide workflows for retrieving or learning optimized prompt values. Prompt engineering tools can facilitate directly learning prompt values (e.g., input element values) based one or more training iterations. Workbench 15 can implement prompt engineering tools in development model 16.

Prompt libraries 17-4 can include pipelines for prompt generation. For example, inputs can be generated using development model 16 itself or other machine-learned models. In this manner, for instance, a first model can process information about a task and output a input for a second model to process in order to perform a step of the task. The second model can be the same as or different from the first model. Workbench 15 can implement prompt generation pipelines in development model 16.

Prompt libraries 17-4 can include pipelines for context injection. For instance, a performance of development model 16 on a particular task can improve if provided with additional context for performing the task. Prompt libraries 17-4 can include software components configured to identify desired context, retrieve the context from an external source (e.g., a database, a sensor, etc.), and add the context to the input prompt. Workbench 15 can implement context injection pipelines in development model 16.

Although various training examples described herein with respect to model development platform 12 refer to “pre-training” and “fine-tuning,” it is to be understood that model alignment toolkit 17 can generally support a wide variety of training techniques adapted for training a wide variety of machine-learned models. Example training techniques can correspond to the example training method 800 described above.

Model development platform 12 can include a model plugin toolkit 18. Model plugin toolkit 18 can include a variety of tools configured for augmenting the functionality of a machine-learned model by integrating the machine-learned model with other systems, devices, and software components. For instance, a machine-learned model can use tools to increase performance quality where appropriate. For instance, deterministic tasks can be offloaded to dedicated tools in lieu of probabilistically performing the task with an increased risk of error. For instance, instead of autoregressively predicting the solution to a system of equations, a machine-learned model can recognize a tool to call for obtaining the solution and pass the system of equations to the appropriate tool. The tool can be a traditional system of equations solver that can operate deterministically to resolve the system of equations. The output of the tool can be returned in response to the original query. In this manner, tool use can allow some example models to focus on the strengths of machine-learned models—e.g., understanding an intent in an unstructured request for a task—while augmenting the performance of the model by offloading certain tasks to a more focused tool for rote application of deterministic algorithms to a well-defined problem.

Model plugin toolkit 18 can include validation tools 18-1. Validation tools 18-1 can include tools that can parse and confirm output(s) of a machine-learned model. Validation tools 18-1 can include engineered heuristics that establish certain thresholds applied to model outputs. For example, validation tools 18-1 can ground the outputs of machine-learned models to structured data sources (e.g., to mitigate “hallucinations”).

Model plugin toolkit 18 can include tooling packages 18-2 for implementing one or more tools that can include scripts or other executable code that can be executed alongside development model 16. Tooling packages 18-2 can include one or more inputs configured to cause machine-learned model(s) to implement the tools (e.g., few-shot prompts that induce a model to output tool calls in the proper syntax, etc.). Tooling packages 18-2 can include, for instance, fine-tuning training data for training a model to use a tool.

Model plugin toolkit 18 can include interfaces for calling external application programming interfaces (APIs) 18-3. For instance, in addition to or in lieu of implementing tool calls or tool code directly with development model 16, development model 16 can be aligned to output instruction that initiate API calls to send or obtain data via external systems.

Model plugin toolkit 18 can integrate with prompt libraries 17-4 to build a catalog of available tools for use with development model 16. For instance, a model can receive, in an input, a catalog of available tools, and the model can generate an output that selects a tool from the available tools and initiates a tool call for using the tool.

Model development platform 12 can include a computational optimization toolkit 19 for optimizing a computational performance of development model 16. For instance, tools for model compression 19-1 can allow development model 16 to be reduced in size while maintaining a desired level of performance. For instance, model compression 19-1 can include quantization workflows, weight pruning and sparsification techniques, etc. Tools for hardware acceleration 19-2 can facilitate the configuration of the model storage and execution formats to operate optimally on different hardware resources. For instance, hardware acceleration 19-2 can include tools for optimally sharding models for distributed processing over multiple processing units for increased bandwidth, lower unified memory requirements, etc. Tools for distillation 19-3 can provide for the training of lighter-weight models based on the knowledge encoded in development model 16. For instance, development model 16 can be a highly performant, large machine-learned model optimized using model development platform 12. To obtain a lightweight model for running in resource-constrained environments, a smaller model can be a “student model” that learns to imitate development model 16 as a “teacher model.” In this manner, for instance, the investment in learning the parameters and configurations of development model 16 can be efficiently transferred to a smaller model for more efficient inference.

Workbench 15 can implement one, multiple, or none of the toolkits implemented in model development platform 12. Workbench 15 can output an output model 20 based on development model 16. Output model 20 can be a deployment version of development model 16. Output model 20 can be a development or training checkpoint of development model 16. Output model 20 can be a distilled, compressed, or otherwise optimized version of development model 16.

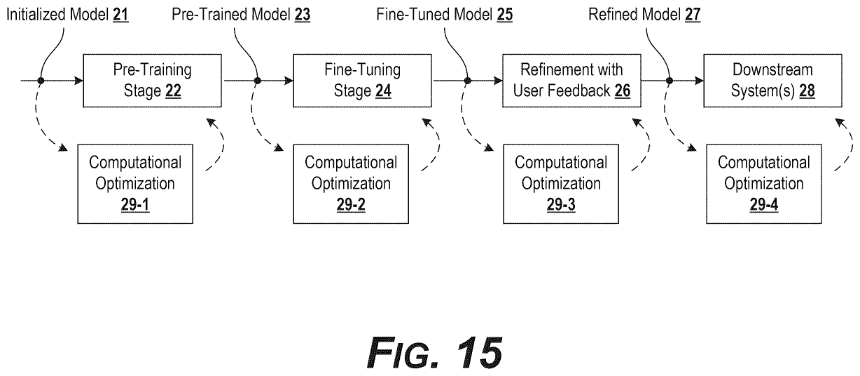

FIG. 15 is a block diagram of an example training flow for training a machine-learned development model 16. One or more portion(s) of the example training flow can be implemented by a computing system that includes one or more computing devices such as, for example, computing systems described with reference to the other figures. Each respective portion of the example training flow can be performed by any (or any combination) of one or more computing devices. Moreover, one or more portion(s) of the example training flow can be implemented on the hardware components of the device(s) described herein, for example, to train one or more systems or models. FIG. 15 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 15 is described with reference to elements/terms described with respect to other systems and figures for exemplary illustrated purposes and is not meant to be limiting. One or more portions of the example training flow can be performed additionally, or alternatively, by other systems.

Initially, development model 16 can persist in an initial state as an initialized model 21. Development model 16 can be initialized with weight values. Initial weight values can be random or based on an initialization schema. Initial weight values can be based on prior pre-training for the same or for a different model.

Initialized model 21 can undergo pre-training in a pre-training stage 22. Pre-training stage 22 can be implemented using one or more pre-training pipelines 17-2 over data from dataset(s) 17-1. Pre-training can be omitted, for example, if initialized model 21 is already pre-trained (e.g., development model 16 contains, is, or is based on a pre-trained foundational model or an expert model).

Pre-trained model 23 can then be a new version of development model 16, which can persist as development model 16 or as a new development model. Pre-trained model 23 can be the initial state if development model 16 was already pre-trained. Pre-trained model 23 can undergo fine-tuning in a fine-tuning stage 24. Fine-tuning stage 24 can be implemented using one or more fine-tuning pipelines 17-3 over data from dataset(s) 17-1. Fine-tuning can be omitted, for example, if a pre-trained model as satisfactory performance, if the model was already fine-tuned, or if other tuning approaches are preferred.

Fine-tuned model 25 can then be a new version of development model 16, which can persist as development model 16 or as a new development model. Fine-tuned model 25 can be the initial state if development model 16 was already fine-tuned. Fine-tuned model 25 can undergo refinement with user feedback 26. For instance, refinement with user feedback 26 can include reinforcement learning, optionally based on human feedback from human users of fine-tuned model 25. As reinforcement learning can be a form of fine-tuning, it is to be understood that fine-tuning stage 24 can subsume the stage for refining with user feedback 26. Refinement with user feedback 26 can produce a refined model 27. Refined model 27 can be output to downstream system(s) 28 for deployment or further development.

In some implementations, computational optimization operations can be applied before, during, or after each stage. For instance, initialized model 21 can undergo computational optimization 29-1 (e.g., using computational optimization toolkit 19) before pre-training stage 22. Pre-trained model 23 can undergo computational optimization 29-2 (e.g., using computational optimization toolkit 19) before fine-tuning stage 24. Fine-tuned model 25 can undergo computational optimization 29-3 (e.g., using computational optimization toolkit 19) before refinement with user feedback 26. Refined model 27 can undergo computational optimization 29-4 (e.g., using computational optimization toolkit 19) before output to downstream system(s) 28. Computational optimization(s) 29-1, . . . , 29-4 can all be the same, all be different, or include at least some different optimization techniques.

### Example Machine-Learned Model Inference System

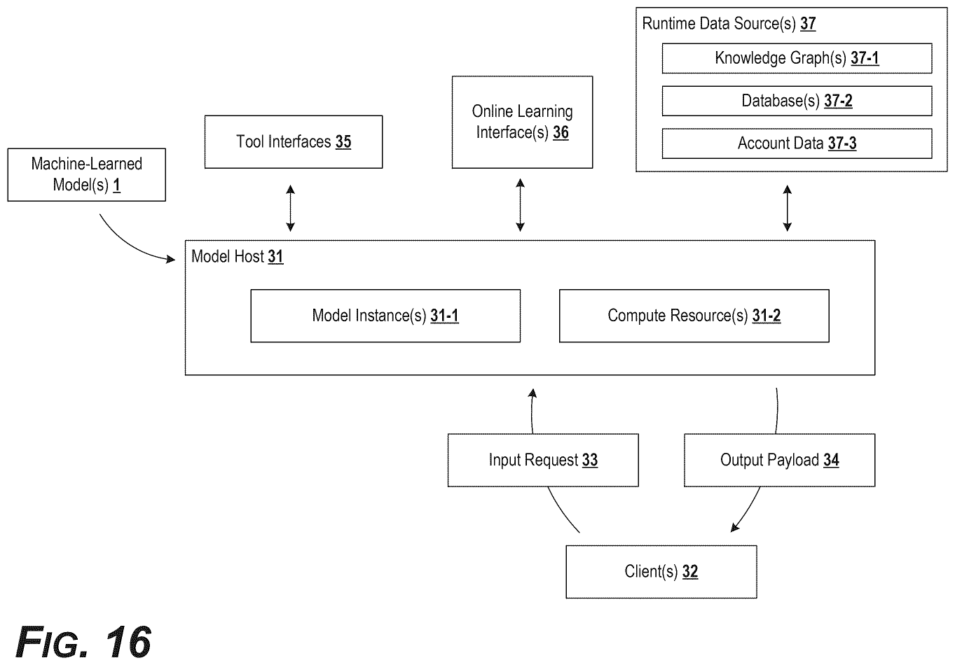

FIG. 16 is a block diagram of an inference system for operating one or more machine-learned model(s) 1 to perform inference (e.g., for training, for deployment, etc.). A model host 31 can receive machine-learned model(s) 1. Model host 31 can host one or more model instance(s) 31-1, which can be one or multiple instances of one or multiple models. Model host 31 can host model instance(s) 31-1 using available compute resources 31-2 associated with model host 31.

Model host 31 can perform inference on behalf of one or more client(s) 32. Client(s) 32 can transmit an input request 33 to model host 31. Using input request 33, model host 31 can obtain input(s) 2 for input to machine-learned model(s) 1. Machine-learned model(s) 1 can process input(s) 2 to generate output(s) 3. Using output(s) 3, model host 31 can return an output payload 34 for responding to input request 33 from client(s) 32. Output payload 34 can include or be based on output(s) 3.

Model host 31 can leverage various other resources and tools to augment the inference task. For instance, model host 31 can communicate with tool interfaces 35 to facilitate tool use by model instance(s) 31-1. Tool interfaces 35 can include local or remote APIs. Tool interfaces 35 can include integrated scripts or other software functionality. Model host 31 can engage online learning interface(s) 36 to facilitate ongoing improvements to machine-learned model(s) 1. For instance, online learning interface(s) 36 can be used within reinforcement learning loops to retrieve user feedback on inferences served by model host 31. Model host 31 can access runtime data source(s) 37 for augmenting input(s) 2 with additional contextual information. For instance, runtime data source(s) 37 can include a knowledge graph 37-1 that facilitates structured information retrieval for information associated with input request(s) 33 (e.g., a search engine service). Runtime data source(s) 37 can include public or private, external or local database(s) 37-2 that can store information associated with input request(s) 33 for augmenting input(s) 2. Runtime data source(s) 37 can include account data 37-3 which can be retrieved in association with a user account corresponding to a client 32 for customizing the behavior of model host 31 accordingly.

Model host 31 can be implemented by one or multiple computing devices or systems. Client(s) 2 can be implemented by one or multiple computing devices or systems, which can include computing devices or systems shared with model host 31.

For example, model host 31 can operate on a server system that provides a machine-learning service to client device(s) that operate client(s) 32 (e.g., over a local or wide-area network). Client device(s) can be end-user devices used by individuals. Client device(s) can be server systems that operate client(s) 32 to provide various functionality as a service to downstream end-user devices.

In some implementations, model host 31 can operate on a same device or system as client(s) 32. Model host 31 can be a machine-learning service that runs on-device to provide machine-learning functionality to one or multiple applications operating on a client device, which can include an application implementing client(s) 32. Model host 31 can be a part of a same application as client(s) 32. For instance, model host 31 can be a subroutine or method implemented by one part of an application, and client(s) 32 can be another subroutine or method that engages model host 31 to perform inference functions within the application. It is to be understood that model host 31 and client(s) 32 can have various different configurations.

Model instance(s) 31-1 can include one or more machine-learned models that are available for performing inference. Model instance(s) 31-1 can include weights or other model components that are stored on in persistent storage, temporarily cached, or loaded into high-speed memory. Model instance(s) 31-1 can include multiple instance(s) of the same model (e.g., for parallel execution of more requests on the same model). Model instance(s) 31-1 can include instance(s) of different model(s). Model instance(s) 31-1 can include cached intermediate states of active or inactive model(s) used to accelerate inference of those models. For instance, an inference session with a particular model may generate significant amounts of computational results that can be re-used for future inference runs (e.g., using a KV cache for transformer-based models). These computational results can be saved in association with that inference session so that session can be executed more efficiently when resumed.

Compute resource(s) 31-2 can include one or more processors (central processing units, graphical processing units, tensor processing units, machine-learning accelerators, etc.) connected to one or more memory devices. Compute resource(s) 31-2 can include a dynamic pool of available resources shared with other processes. Compute resource(s) 31-2 can include memory devices large enough to fit an entire model instance in a single memory instance.

Compute resource(s) 31-2 can also shard model instance(s) across multiple memory devices (e.g., using data parallelization or tensor parallelization, etc.). This can be done to increase parallelization or to execute a large model using multiple memory devices which individually might not be able to fit the entire model into memory.

Input request 33 can include data for input(s) 2. Model host 31 can process input request 33 to obtain input(s) 2. Input(s) 2 can be obtained directly from input request 33 or can be retrieved using input request 33. Input request 33 can be submitted to model host 31 via an API.

Model host 31 can perform inference over batches of input requests 33 in parallel. For instance, a model instance 31-1 can be configured with an input structure that has a batch dimension. Separate input(s) 2 can be distributed across the batch dimension (e.g., rows of an array). The separate input(s) 2 can include completely different contexts. The separate input(s) 2 can be multiple inference steps of the same task. The separate input(s) 2 can be staggered in an input structure, such that any given inference cycle can be operating on different portions of the respective input(s) 2. In this manner, for instance, model host 31 can perform inference on the batch in parallel, such that output(s) 3 can also contain the batch dimension and return the inference results for the batched input(s) 2 in parallel. In this manner, for instance, batches of input request(s) 33 can be processed in parallel for higher throughput of output payload(s) 34.

Output payload 34 can include or be based on output(s) 3 from machine-learned model(s) 1. Model host 31 can process output(s) 3 to obtain output payload 34. This can include chaining multiple rounds of inference (e.g., iteratively, recursively, across the same model(s) or different model(s)) to arrive at a final output for a task to be returned in output payload 34. Output payload 34 can be transmitted to client(s) 32 via an API.

Online learning interface(s) 36 can facilitate reinforcement learning of machine-learned model(s) 1. Online learning interface(s) 36 can facilitate reinforcement learning with human feedback (RLHF). Online learning interface(s) 36 can facilitate federated learning of machine-learned model(s) 1.

Model host 31 can execute machine-learned model(s) 1 to perform inference for various tasks using various types of data. For example, various different input(s) 2 and output(s) 3 can be used for various different tasks. In some implementations, input(s) 2 can be or otherwise represent image data. Machine-learned model(s) 1 can process the image data to generate an output. As an example, machine-learned model(s) 1 can process the image data to generate an image recognition output (e.g., a recognition of the image data, a latent embedding of the image data, an encoded representation of the image data, a hash of the image data, etc.). As another example, machine-learned model(s) 1 can process the image data to generate an image segmentation output. As another example, machine-learned model(s) 1 can process the image data to generate an image classification output. As another example, machine-learned model(s) 1 can process the image data to generate an image data modification output (e.g., an alteration of the image data, etc.). As another example, machine-learned model(s) 1 can process the image data to generate an encoded image data output (e.g., an encoded and/or compressed representation of the image data, etc.). As another example, machine-learned model(s) 1 can process the image data to generate an upscaled image data output. As another example, machine-learned model(s) 1 can process the image data to generate a prediction output.

In some implementations, the task is a computer vision task. In some cases, input(s) 2 includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

In some implementations, input(s) 2 can be or otherwise represent natural language data. Machine-learned model(s) 1 can process the natural language data to generate an output. As an example, machine-learned model(s) 1 can process the natural language data to generate a language encoding output. As another example, machine-learned model(s) 1 can process the natural language data to generate a latent text embedding output. As another example, machine-learned model(s) 1 can process the natural language data to generate a translation output. As another example, machine-learned model(s) 1 can process the natural language data to generate a classification output. As another example, machine-learned model(s) 1 can process the natural language data to generate a textual segmentation output. As another example, machine-learned model(s) 1 can process the natural language data to generate a semantic intent output. As another example, machine-learned model(s) 1 can process the natural language data to generate an upscaled text or natural language output (e.g., text or natural language data that is higher quality than the input text or natural language, etc.). As another example, machine-learned model(s) 1 can process the natural language data to generate a prediction output (e.g., one or more predicted next portions of natural language content).

In some implementations, input(s) 2 can be or otherwise represent speech data (e.g., data describing spoken natural language, such as audio data, textual data, etc.). Machine-learned model(s) 1 can process the speech data to generate an output. As an example, machine-learned model(s) 1 can process the speech data to generate a speech recognition output. As another example, machine-learned model(s) 1 can process the speech data to generate a speech translation output. As another example, machine-learned model(s) 1 can process the speech data to generate a latent embedding output. As another example, machine-learned model(s) 1 can process the speech data to generate an encoded speech output (e.g., an encoded and/or compressed representation of the speech data, etc.). As another example, machine-learned model(s) 1 can process the speech data to generate an upscaled speech output (e.g., speech data that is higher quality than the input speech data, etc.). As another example, machine-learned model(s) 1 can process the speech data to generate a textual representation output (e.g., a textual representation of the input speech data, etc.). As another example, machine-learned model(s) 1 can process the speech data to generate a prediction output.

In some implementations, input(s) 2 can be or otherwise represent latent encoding data (e.g., a latent space representation of an input, etc.). Machine-learned model(s) 1 can process the latent encoding data to generate an output. As an example, machine-learned model(s) 1 can process the latent encoding data to generate a recognition output. As another example, machine-learned model(s) 1 can process the latent encoding data to generate a reconstruction output. As another example, machine-learned model(s) 1 can process the latent encoding data to generate a search output. As another example, machine-learned model(s) 1 can process the latent encoding data to generate a reclustering output. As another example, machine-learned model(s) 1 can process the latent encoding data to generate a prediction output.

In some implementations, input(s) 2 can be or otherwise represent statistical data. Statistical data can be, represent, or otherwise include data computed and/or calculated from some other data source. Machine-learned model(s) 1 can process the statistical data to generate an output. As an example, machine-learned model(s) 1 can process the statistical data to generate a recognition output. As another example, machine-learned model(s) 1 can process the statistical data to generate a prediction output. As another example, machine-learned model(s) 1 can process the statistical data to generate a classification output. As another example, machine-learned model(s) 1 can process the statistical data to generate a segmentation output. As another example, machine-learned model(s) 1 can process the statistical data to generate a visualization output. As another example, machine-learned model(s) 1 can process the statistical data to generate a diagnostic output.

In some implementations, input(s) 2 can be or otherwise represent sensor data. Machine-learned model(s) 1 can process the sensor data to generate an output. As an example, machine-learned model(s) 1 can process the sensor data to generate a recognition output. As another example, machine-learned model(s) 1 can process the sensor data to generate a prediction output. As another example, machine-learned model(s) 1 can process the sensor data to generate a classification output. As another example, machine-learned model(s) 1 can process the sensor data to generate a segmentation output. As another example, machine-learned model(s) 1 can process the sensor data to generate a visualization output. As another example, machine-learned model(s) 1 can process the sensor data to generate a diagnostic output. As another example, machine-learned model(s) 1 can process the sensor data to generate a detection output.

In some implementations, machine-learned model(s) 1 can be configured to perform a task that includes encoding input data for reliable and/or efficient transmission or storage (and/or corresponding decoding). For example, the task may be an audio compression task. The input may include audio data and the output may comprise compressed audio data. In another example, the input includes visual data (e.g. one or more images or videos), the output comprises compressed visual data, and the task is a visual data compression task. In another example, the task may comprise generating an embedding for input data (e.g. input audio or visual data). In some cases, the input includes audio data representing a spoken utterance and the task is a speech recognition task. The output may comprise a text output which is mapped to the spoken utterance. In some cases, the task comprises encrypting or decrypting input data. In some cases, the task comprises a microprocessor performance task, such as branch prediction or memory address translation.

In some implementations, the task is a generative task, and machine-learned model(s) 1 can be configured to output content generated in view of input(s) 2. For instance, input(s) 2 can be or otherwise represent data of one or more modalities that encodes context for generating additional content.

In some implementations, the task can be a text completion task. Machine-learned model(s) 1 can be configured to process input(s) 2 that represent textual data and to generate output(s) 3 that represent additional textual data that completes a textual sequence that includes input(s) 2. For instance, machine-learned model(s) 1 can be configured to generate output(s) 3 to complete a sentence, paragraph, or portion of text that follows from a portion of text represented by input(s) 2.

In some implementations, the task can be an instruction following task. Machine-learned model(s) 1 can be configured to process input(s) 2 that represent instructions to perform a function and to generate output(s) 3 that advance a goal of satisfying the instruction function (e.g., at least a step of a multi-step procedure to perform the function). Output(s) 3 can represent data of the same or of a different modality as input(s) 2. For instance, input(s) 2 can represent textual data (e.g., natural language instructions for a task to be performed) and machine-learned model(s) 1 can process input(s) 2 to generate output(s) 3 that represent textual data responsive to the instructions (e.g., natural language responses, programming language responses, machine language responses, etc.). Input(s) 2 can represent image data (e.g., image-based instructions for a task to be performed, optionally accompanied by textual instructions) and machine-learned model(s) 1 can process input(s) 2 to generate output(s) 3 that represent textual data responsive to the instructions (e.g., natural language responses, programming language responses, machine language responses, etc.). One or more output(s) 3 can be iteratively or recursively generated to sequentially process and accomplish steps toward accomplishing the requested functionality. For instance, an initial output can be executed by an external system or be processed by machine-learned model(s) 1 to complete an initial step of performing a function. Multiple steps can be performed, with a final output being obtained that is responsive to the initial instructions.

In some implementations, the task can be a question answering task. Machine-learned model(s) 1 can be configured to process input(s) 2 that represent a question to answer and to generate output(s) 3 that advance a goal of returning an answer to the question (e.g., at least a step of a multi-step procedure to perform the function). Output(s) 3 can represent data of the same or of a different modality as input(s) 2. For instance, input(s) 2 can represent textual data (e.g., natural language instructions for a task to be performed) and machine-learned model(s) 1 can process input(s) 2 to generate output(s) 3 that represent textual data responsive to the question (e.g., natural language responses, programming language responses, machine language responses, etc.). Input(s) 2 can represent image data (e.g., image-based instructions for a task to be performed, optionally accompanied by textual instructions) and machine-learned model(s) 1 can process input(s) 2 to generate output(s) 3 that represent textual data responsive to the question (e.g., natural language responses, programming language responses, machine language responses, etc.). One or more output(s) 3 can be iteratively or recursively generated to sequentially process and accomplish steps toward answering the question. For instance, an initial output can be executed by an external system or be processed by machine-learned model(s) 1 to complete an initial step of obtaining an answer to the question (e.g., querying a database, performing a computation, executing a script, etc.). Multiple steps can be performed, with a final output being obtained that is responsive to the question.

In some implementations, the task can be an image generation task. Machine-learned model(s) 1 can be configured to process input(s) 2 that represent context regarding a desired portion of image content. The context can include text data, image data, audio data, etc. Machine-learned model(s) 1 can be configured to generate output(s) 3 that represent image data that depicts imagery related to the context. For instance, machine-learned model(s) 1 can be configured to generate pixel data of an image. Values for channel(s) associated with the pixels in the pixel data can be selected based on the context (e.g., based on a probability determined based on the context).

In some implementations, the task can be an audio generation task. Machine-learned model(s) 1 can be configured to process input(s) 2 that represent context regarding a desired portion of audio content. The context can include text data, image data, audio data, etc. Machine-learned model(s) 1 can be configured to generate output(s) 3 that represent audio data related to the context. For instance, machine-learned model(s) 1 can be configured to generate waveform data in the form of an image (e.g., a spectrogram). Values for channel(s) associated with pixels of the image can be selected based on the context. Machine-learned model(s) 1 can be configured to generate waveform data in the form of a sequence of discrete samples of a continuous waveform. Values of the sequence can be selected based on the context (e.g., based on a probability determined based on the context).

In some implementations, the task can be a data generation task. Machine-learned model(s) 1 can be configured to process input(s) 2 that represent context regarding a desired portion of data (e.g., data from various data domains, such as sensor data, image data, multimodal data, statistical data, etc.). The desired data can be, for instance, synthetic data for training other machine-learned models. The context can include arbitrary data type(s). Machine-learned model(s) 1 can be configured to generate output(s) 3 that represent data that aligns with the desired data. For instance, machine-learned model(s) 1 can be configured to generate data values for populating a dataset. Values for the data object(s) can be selected based on the context (e.g., based on a probability determined based on the context).

### Additional Disclosure

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

What is claimed is:

1. A computer-implemented method for machine-learned generation of data insight summaries, comprising:
obtaining, by a computing system comprising one or more computing devices, numerical time series data comprising a plurality of numerical values associated with a plurality of times;
identifying, by the computing system based on the numerical time series data, one or more first mathematical relationships in the numerical time series data;
generating, by the computing system based at least in part on the one or more first mathematical relationships, a first input context comprising first natural language data indicative of the one or more first mathematical relationships;
providing, by the computing system, the first input context to a first machine-learned sequence processing model;
generating, by the first machine-learned sequence processing model based at least in part on the first input context, one or more outputs describing the one or more first mathematical relationships; and
outputting, by the computing system, the one or more outputs.

2. The computer-implemented method of claim 1, wherein the one or more outputs comprise a first candidate output, and further comprising:
providing, by the computing system to a second machine-learned sequence processing model, a second input context comprising at least one of the first natural language data and second data indicative of the one or more first mathematical relationships;
providing, by the computing system to the second machine-learned sequence processing model, the first candidate output; and
generating, by the second machine-learned sequence processing model based on the first candidate output and the second input context, an accuracy score indicative of a degree to which the first candidate output accurately describes the one or more first mathematical relationships;
wherein outputting the one or more outputs is based at least in part on the accuracy score.

3. The computer-implemented method of claim 2, further comprising:
determining, by the computing system based at least in part on the accuracy score, whether to generate a second candidate output using the first machine-learned sequence processing model.

4. The computer-implemented method of claim 2, further comprising:
generating, by the computing system using the second machine-learned sequence processing model based at least in part on the first candidate output, an evaluation score comprising at least one of:
a readability score; and
an actionability score;
wherein outputting the one or more outputs is based at least in part on the evaluation score.

5. The computer-implemented method of claim 1, further comprising:
classifying, by the computing system, the one or more first mathematical relationships into one or more classes of a plurality of mathematical relationship classes;
wherein a format of the first natural language data of the first input context comprises a class-dependent structured format associated with the one or more classes.

6. The computer-implemented method of claim 5, wherein the plurality of mathematical relationship classes comprises:
a single-line time series trend class;
a multiple-line time series trend class;
a first comparison class comprising one or more comparisons between single numerical values;
a second comparison class comprising comparisons between non-time-series pluralities of numerical values;
a multiple-numerical-value non-comparison class; and
a single-numerical-value non-comparison class.

7. The computer-implemented method of claim 1, further comprising:
receiving, by the computing system from a user, user input indicative of a user evaluation of the one or more outputs; and
updating, by the computing system based on the user input, at least one of the first machine-learned sequence processing model and a second machine-learned sequence processing model configured to evaluate outputs of the first machine-learned sequence processing model.

8. The computer-implemented method of claim 1, wherein the numerical time series data comprises user-specific time series data associated with a user, and further comprising:
obtaining, by the computing system, general time series data associated with a plurality of users;
wherein the one or more first mathematical relationships comprise a comparison between the general time series data and the user-specific time series data.

9. The computer-implemented method of claim 1, wherein the first input context further comprises:
one or more fill-in-the-blank output templates; and
one or more instructions to fill in one or more parts of at least one of the one or more fill-in-the-blank output templates.

10. The computer-implemented method of claim 9, wherein each of the one or more fill-in-the-blank output templates comprises:
at least one title portion;
at least one summary portion; and
at least one segment analysis portion.

11. The computer-implemented method of claim 1, further comprising:
providing, by the computing system to the first machine-learned sequence processing model, a plurality of input-output pairs comprising:
at least one input value comprising second natural language data indicative of one or more second mathematical relationships; and
at least one output value comprising a natural language description of the one or more second mathematical relationships;
wherein the one or more outputs are generated based at least in part on the plurality of input-output pairs.

12. The computer-implemented method of claim 1, wherein the first input context further comprises general content analytics knowledge, and wherein the one or more outputs are generated based at least in part on the general content analytics knowledge.

13. The computer-implemented method of claim 1, further comprising:
identifying, by the computing system based at least in part on the numerical time series data, one or more second mathematical relationships in one or more subsets of the numerical time series data;
generating, by the computing system based at least in part on the one or more second mathematical relationships, second natural language data indicative of the one or more second mathematical relationships;
generating, by the computing system based at least in part on the one or more second mathematical relationships, second natural language data indicative of the one or more second mathematical relationships; and
providing, by the computing system to the first machine-learned sequence processing model, the second natural language data as part of the first input context or a second input context;
wherein the one or more outputs are generated based at least in part on the second natural language data, and wherein the one or more outputs comprise a segment analysis.

14. The computer-implemented method of claim 13, further comprising:
generating, by the computing system based at least in part on the one or more first mathematical relationships, a chart associated with the one or more outputs;
providing, by the computing system, the chart to a user; and
providing, by the computing system to the user, an interface component configured to cause the chart to be filtered according to the one or more subsets when the interface component is interacted with by the user.

15. The computer-implemented method of claim 14, wherein each numerical value is associated with one or more times and one or more other properties different from time, and identifying the one or more second mathematical relationships comprises:
determining, based on the one or more other properties different from time, the one or more subsets.

16. The computer-implemented method of claim 15, wherein the one or more other properties different from time comprise at least one of:
demographic data associated with one or more users; and
internet traffic data associated with one or more internet interactions.

17. The computer-implemented method of claim 15, wherein the one or more subsets is determined based at least in part on a comparison between the one or more subsets and the numerical time series data as a whole.

18. The method of claim 1, wherein the numerical time series data comprises content analytics data.

19. A computing system comprising one or more processors and one or more non-transitory computer-readable media storing instructions that are executable by the one or more processors to cause the computing system to perform operations, the operations comprising:
obtaining numerical time series data comprising a plurality of numerical values associated with a plurality of times;
identifying, by the computing system based on the numerical time series data, one or more first mathematical relationships in the numerical time series data;
generating, based at least in part on the one or more first mathematical relationships,, a first input context comprising first natural language data indicative of the one or more first mathematical relationships;
providing the first input context to a first machine-learned sequence processing model;
generating, by the first machine-learned sequence processing model based at least in part on the first input context, one or more outputs describing the one or more first mathematical relationships; and
outputting the one or more outputs.

20. One or more non-transitory computer-readable media storing instructions that are executable by a computing system to perform operations, the operations comprising:
obtaining numerical time series data comprising a plurality of numerical values associated with a plurality of times;
identifying, by the computing system based on the numerical time series data, one or more first mathematical relationships in the numerical time series data;
generating, based at least in part on the one or more first mathematical relationships, a first input context comprising first natural language data indicative of the one or more first mathematical relationships;
providing the first input context to a first machine-learned sequence processing model;
generating, by the first machine-learned sequence processing model based on the first input context, one or more outputs describing the one or more first mathematical relationships; and
outputting the one or more outputs.
